(19) United States
(12) Patent Application Publication
(10) Pub. No.: US 2026/0095861 A1
(43) Pub. Date: Apr. 2, 2026

(54) METHODS ON HYBRID MEASUREMENT FOR LP-WUS

(71) Applicant: INTERDIGITAL PATENT HOLDINGS, INC., Wilmington, DE (US)

(72) Inventors: Young Woo KWAK, Woodbury, NY (US); Moon IL LEE, Melville, NY (US); Virgil COMSA, Montreal (CA); Nazli KHAN BEIGI, Longueuil (CA); Jongwoo HONG, New York, NY (US)

(73) Assignee: INTERGIDITAL PATENT HOLDINGS, INC., Wilmington, DE (US)

(21) Appl. No.: 18/902,311

(22) Filed: Sep. 30, 2024

(51) Int. Cl. H04W 52/02; H04L 5/00; H04W 24/10; H04W 68/02

(52) U.S. Cl. CPC H04W 52/0235; H04L 5/0051; H04W 24/10; H04W 68/02

(57) ABSTRACT

A wireless transmit/receive unit (WTRU) is disclosed. The WTRU may comprise a processor configured to perform a first measurement of one or more reference signals received by a first radio. The processor may also be configured to cause a second radio to monitor for a low power wake-up signal based on a condition that the first measurement is larger than a first entry threshold. Further, the processor may be configured to perform a second measurement of one or more reference signals received, during a first measurement window, by the second radio based on a condition that the first measurement is larger than a second entry threshold. In addition, the processor may be configured to perform a third measurement of one or more reference signals received, during a second measurement window, by the second radio based on a condition that the first measurement is larger than a third entry threshold.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Methods and apparatus for determining conditions to enable monitoring of low wake-up power signals. The method and apparatus may also determine conditions for discontinuing monitoring for low power wake-up signals. In one aspect, a wireless transmit/receive unit (WTRU) is disclosed. The WTRU may comprise a processor configured to perform a first measurement of one or more reference signals received by a first radio. The processor may also be configured to cause a second radio to monitor for a low power wake-up signal based on a condition that the first measurement is larger than a first entry threshold. Further, the processor may be configured to perform a second measurement of one or more reference signals received, during a first measurement window, by the second radio based on a condition that the first measurement is larger than a second entry threshold. In addition, the processor may be configured to perform a third measurement of one or more reference signals received, during a second measurement window, by the second radio based on a condition that the first measurement is larger than a third entry threshold.

In another aspect, a wireless transmit/receive unit (WTRU) is disclosed. The WTRU may comprise a first radio, a second radio, and a processor. The processor may be configured to perform a first measurement of one or more reference signals received by the second radio. The processor may also be configured to cause the second radio to stop monitoring for a low-power wake up signal based on a condition that the first measurement is below a first exit threshold. Further, the processor may be configured to perform a second measurement of one or more reference signals received, during a first measurement window, by the first radio based on a condition that the first measurement is below a second exit threshold. In addition, the processor may be configured to perform a third measurement of one or more reference signals received, during a second measurement window, by the first radio based on a condition that the first measurement is larger than a third entry threshold.

In yet another aspect, a method implemented by a wireless transmit/receive unit (WTRU) is disclosed. The method may include performing a first measurement of one or more reference signals received by a first radio. The method may also include causing a second radio to monitor for a low power wake-up signal based on a condition that the first measurement is larger than a first entry threshold. Further, the method may include performing a second measurement of one or more reference signals received, during a first measurement window, by the second radio based on a condition that the first measurement is larger than a second entry threshold. In addition, the method may include performing a third measurement of one or more reference signals received, during a second measurement window, by the second radio based on a condition that the first measurement is larger than a third entry threshold.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a wireless transmit/receive unit (WTRU), according to an exemplary embodiment;

FIG. 3 illustrates an example of an idle mode wake-up signal in LTE Release 15;

FIG. 4 illustrates an example of the operation of a WTRU for Release 16 without PEI and Release 17 with PEI;

FIG. 5 illustrates a flow diagram of a method for determining entry conditions for a low power radio, according to an exemplary embodiment;

FIG. 6 illustrates a flow diagram of a method for determining exit conditions for a low power radio, according to an exemplary embodiment;

FIG. 7 illustrates a flow diagram of a method for determining conditions for cell camping, according to an exemplary embodiment; and

FIG. 8 illustrates a flow diagram of a method for determining neighboring cell measurement relaxation, according to an exemplary embodiment.

### DETAILED DESCRIPTION

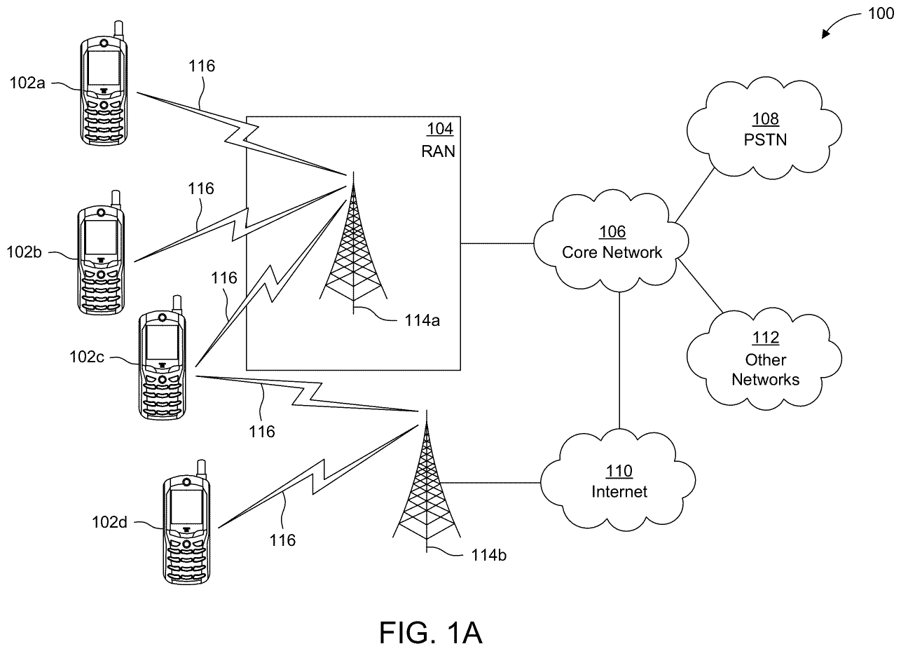

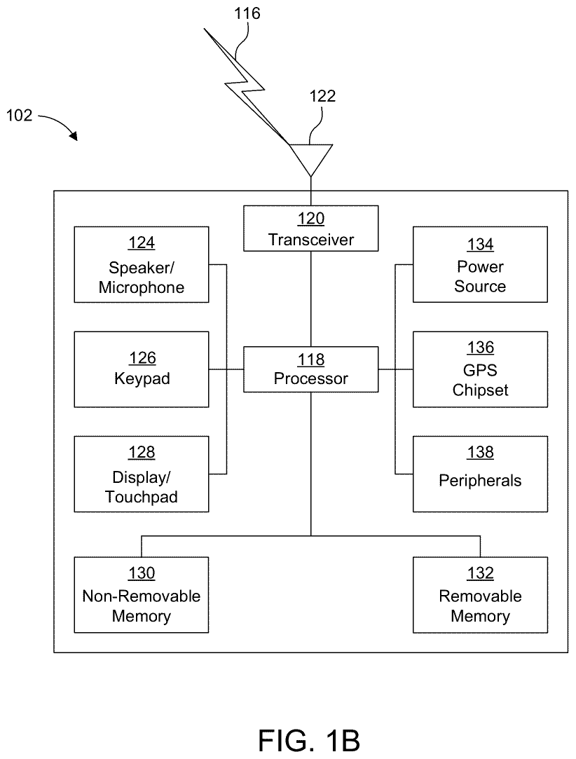

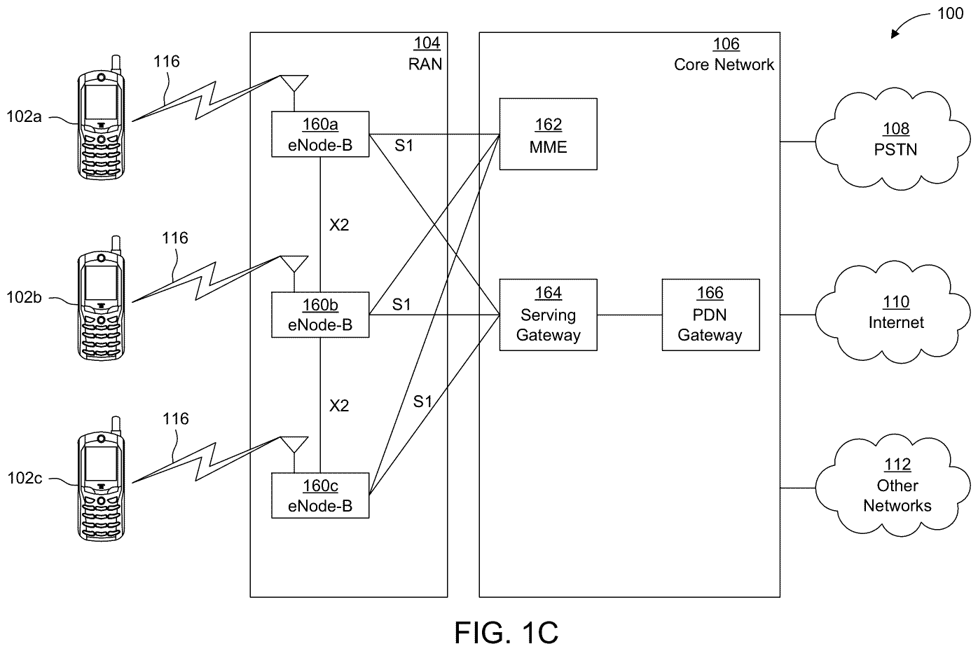

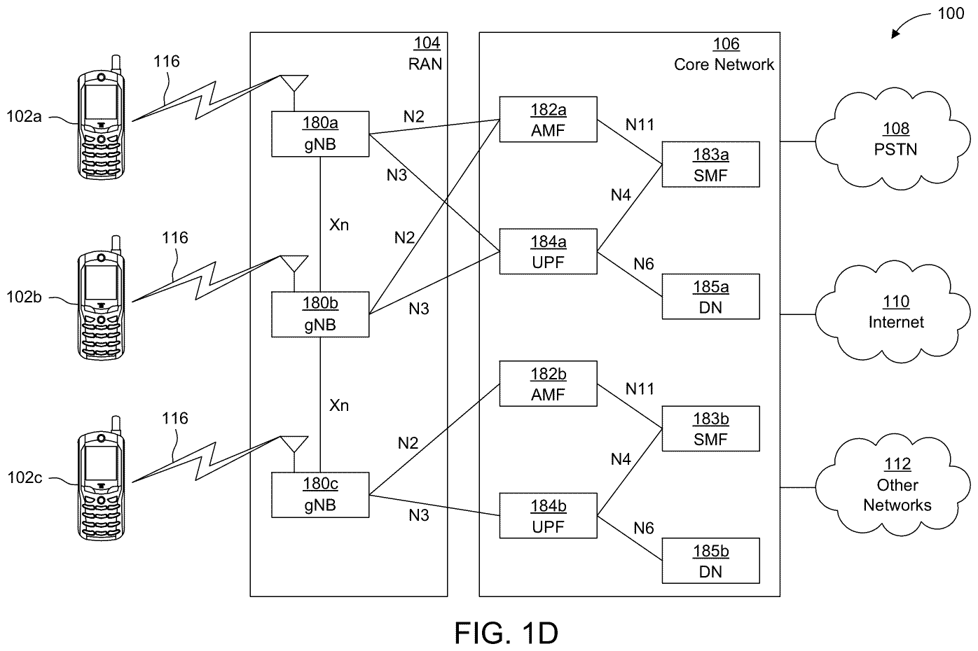

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Considering receiver architectures and low coverage of low power wake-up Receiver (LR), supported bands and available bandwidths may not be identical with MR bands and bandwidths. As a result, WTRU procedures including entry/exit of LP-WUS monitoring, RRM/RLM measurement/offloading and wake-up delay for monitoring PDCCH may be inaccurate and additional measurement by utilizing direct measurement may be needed.

Accurate channel measurement is important for LP-WUS as the channel measurement is used for overall WTRU operation including entry/exit condition of LP-WUS monitoring, RRM/RLM measurement offloading from MR to LR and neighboring cell measurement relaxation. For example, if inaccurate measurement is used for entry/exit conditions, the WTRU may activate LP-WUS monitoring based on inaccurate measurement and quickly deactivate the LP-WUS monitoring due to lack of LR coverage. One solution for achieving accurate measurement is directly performing LR measurement to identify LR coverage, however, activation of LR in addition to activated MR requires additional power consumption.

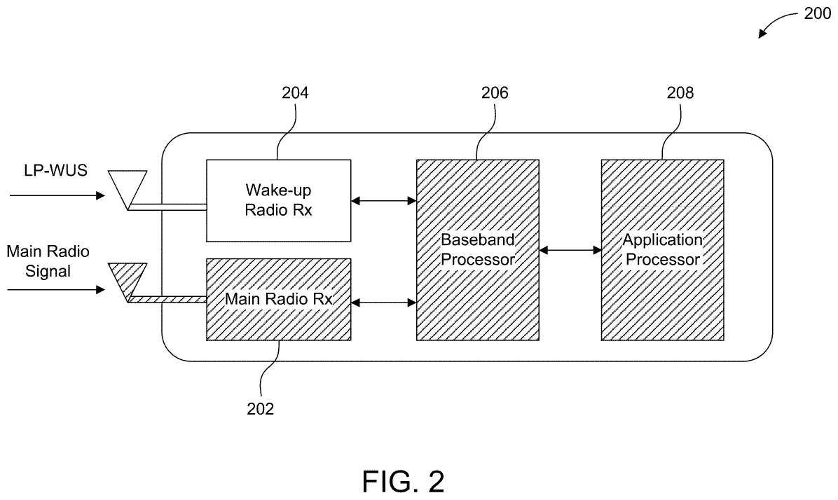

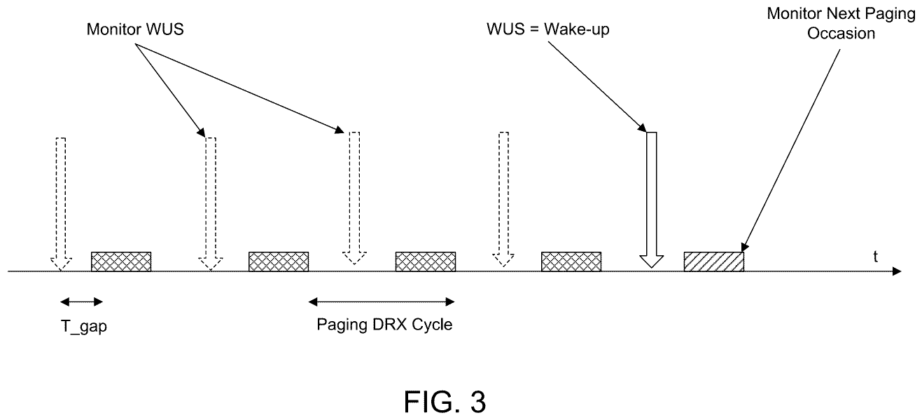

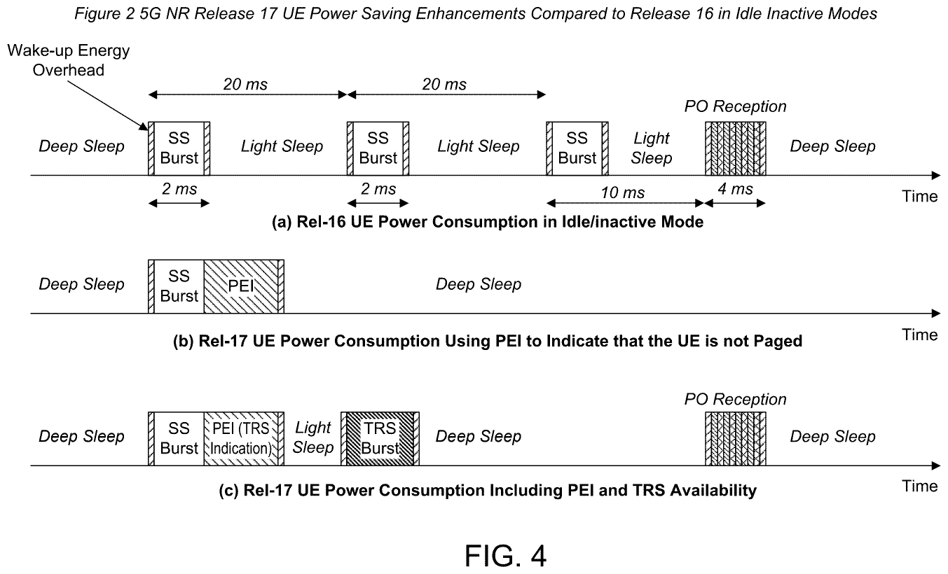

Referring now to FIG. 2, an exemplary WTRU 200 is illustrated. The WTRU 200 may have a first radio and a second radio. The first radio may be a main radio (MR) 202 and the second radio may be a low power wake-up radio (e.g., LP-WUR 204). The type of LP-WUR 204 (e.g., the second radio) may be a OOK-based radio or receiver, a OFDM-based radio or receiver, or any other suitable receiver. The LP-WUR 204 can reduce power consumption of the WTRU 200. For example, the LP-WUR 204 can monitor wake-up signals (WUSs) and trigger and/or wake-up the MR 202 dedicated for data and control signal transmission/reception. The WTRU 200 may also include a baseband processor 206 and an application processor 208.

The LP-WUR 204 of the WTRU 200 may be configured with monitoring windows to monitor and detect potential LP-WUSs. The LP-WUR 204 may be configured with a duty cycle for the monitoring situations, where the duty cycle and the monitoring windows may be selected to match with LP-WUS transmission time from a Network (NW) or base station. The time and frequency synchronization of the WTRU 200 are based on receiving Synchronization Signal Blocks (SSB) and using Primary Synchronization Signal (PSS) and/or Secondary Synchronization Signal (SSS) for synchronization. For example, the WTRU 200 may receive a synchronization signal/physical broadcast channel (SS/PBCH) block. The SS/PBCH block (SSB) may include a primary synchronization signal (PSS), a secondary synchronization signal (SSS), and a physical broadcast channel (PBCH). The WTRU 200 may monitor, receive, or attempt to decode one or more SSBs during initial access, initial synchronization, radio link monitoring (RLM), cell search, cell switching, and so forth.

The WTRU 200 may receive the SSBs during an “ON mode” of the MR 202, where the WTRU 200 may use the received SSB for synchronization. However, in cases where the MR 202 is configured with a long “OFF mode” or sleeping periods, the clock frequency may drift at the WTRU 200. The clock frequency drift or frequency error may result in inaccuracy in the duty cycle of the LP-WUR 204. The difference in the clock of the NW and the clock frequency of the LP-WUR 204 may result in time mismatch between the LP-WUS transmission time from the NW and a monitoring window of the LP-WUR 204. The time mismatch may lead to failed detection of LP-WUS.

To avoid the time mismatch between the LP-WUS transmission time from NW and a monitoring window of the LP-WUR 204, the WTRU 200 may be configured to detect and receive periodic Low Power Synchronization Signals (LP-SS) to achieve accurate synchronization at the LP-WUR 204. LP-SS may be based on On-Off Keying (OOK) symbols forming binary sequences, where the WTRU 200 with a LP-WUS configuration may use the LP-WUR 204 (e.g., based on OOK receivers) to detect and receive the LP-SS.

The LP-SS may be used for time and frequency synchronization with the serving cell. Moreover, the WTRU 200 may use the LP-SS for RRM measurements. As such, the NW may configure the LP-SS sequence associated to the serving cell in addition to a number of candidate LP-SS sequences associated with one or more neighbor cells, where the WTRU 200 can measure RRM measurements accordingly, for the serving cell and configured neighbor cells, respectively.

The WTRU 200 may be configured to use one or more sets of reference signals (RSs) to measure one or more cells. A base station may transmit the RSs and associated DL signals to the WTRU via SIB (e.g., cell-specific) and/or RRC dedicated message (e.g., WTRU-specific). The WTRU 200 may be configured to measure the reference or downlink (DL) signals by via the MR (e.g., MR 202 or first radio) and/or the LR (e.g., the LP-WUR 204 or second radio). In one example, the WTRU 200 may measure a first set of the RSs received by the MR 202. The first set of the RSs may include at least one DL signal (e.g., SS/PBCH/SSB/SSS). Each set of the RSs may be associated with at least one cell (e.g., serving cell and/or neighboring cell). The measurement value of the DL signal received by the MR 202 (e.g., first radio) may include one or more measurement values (e.g., SS-RSRP and/or SS-RSRQ and/or SS-SINR). Further, the WTRU may measure a second set of the RSs received by the LP-WUR 204. The second set of the RSs may include at least one DL signal. For example, the DL signal received by the LP-WUR 204 may include one or more measurement values (e.g., LP-RSSI and/or LP-RSRP and/or LP-RSRQ and/or LP-SINR).

The WTRU 200 may be configured with one or more thresholds (e.g., for MR (i.e., MR 202) and/or LR (i.e., LP-WUR 204)) for entry and/or exit condition for LP-WUS monitoring and/or RRM relaxation for serving/neighboring cell measurements. For example, the WTRU 200 may be configured with a threshold for the MR 202 (e.g., first radio) and the LP-WUR 204 (e.g., second radio) with (pre-)configured offset/compensate value(s). The measurement results of the LP-WUR 204 (e.g., second radio) may be applied with the (pre-)configured offset/compensate value(s). The (pre-)configured offset value (e.g., dBm and/or dB) of RSRP/RSRQ/SINR may be applied to the measurement results with the LP-WUR 204 (e.g., second radio).

The base station or network (NW) may transmit a configuration of thresholds with conditions to the WTRU 200 via SIB (e.g., cell-specific) and/or RRC dedicated message (e.g., WTRU-specific) and/or the WTRU 200 may be pre-configured with one or more thresholds and/or conditions. If the network or base station does not provide the threshold for the LP-WUR 204 (e.g., second radio), the WTRU 200 may configure a threshold for the MR 202 (e.g., first radio) and applied the (pre-) configured offset value to the received threshold for the MR 202 (e.g., first radio). In some examples, the thresholds may be associated with the MR 202 (e.g., the first radio) and/or LP-WUR 204 (e.g., second radio). In other examples, the WTRU 200 may be configured with one or more threshold (e.g., bandwidth). In one example, the WTRU 200 may be configured with a bandwidth threshold for triggering measurements by the MR 202. The bandwidth threshold may comprise the size of bandwidth (e.g., number of PRBs, 5 MHz, 10 MHz, etc). In other examples, the WTRU 200 may be configured with a quality threshold associated measured value (e.g., RSSI/RSRP/RSRQ/SINR and LP-RSSI/LP-RSRP/LP-RSRQ/LP-SINR). The thresholds may also be associated with a first DL signal and/or a second DL signal. The WTRU 200 may measure the first DL signal via the MR (e.g., first radio) and/or the LP-WUR 204 (e.g., second radio) and the WTRU 200 may measure the second DL signal via the LP-WUR 204 (e.g., second radio).

The WTRU 200 may determine measurements of intra-frequency cells, NR inter-frequency cells, and/or inter-RAT frequency cells according to measurement rules or procedures based on a current Srxlev value (e.g., cell selection RX level value) of the serving cell and/or a current Squal value (e.g., cell selection quality value) of the serving cell. The Srxlev value may indicate a RSRP value (e.g., SS-RSRP/LP-RSRP) and the Squal value may indicate RSRQ value (e.g., SS-RSRQ/LP-RSRQ). The WTRU 200 may determine the intra-frequency measurements based on the measurement results. The WTRU 200 may perform measurements of NR inter-frequency cells of equal or lower priority or inter-RAT frequency cells of lower priority based on the measurement results.

The WTRU 200 may be configured for relaxed RRM measurement when a condition (e.g., cell re-selection procedure and relaxation threshold) is satisfied to the quality of the serving cell measurement with MR 202 or the LP-WUR 204. The quality for each of the relaxation thresholds may be associated with measurement results of the MR 202 or the LP-WUR 204 (e.g., LR). For example, the WTRU 200 may perform a relaxed RRM measurement for intra frequency/inter-frequency, if the serving cell measurements via MR 202 is above the quality for relaxation threshold of the MR. For example, the WTRU 200 may perform relaxed RRM measurement for intra frequency/inter-frequency if the serving cell measurements via the LP-WUR 204 is above the quality for relaxation threshold of the LR.

The WTRU 200 may be configured with one or more measurement configurations including periodicities (e.g., msec) associated with the serving cell measurement results. Each of the configurations may be associated with a periodicity of relaxed measurement (e.g., msec). Each of the relaxed configurations may be applied if the threshold (e.g., relaxation threshold) is satisfied. In one example, the high quality of the serving cell measurement (e.g., high measurement value of RSSI/RSRP/RSRQ/SINR) may be associated with a relaxed measurement (e.g., relaxed/longer measurement cycle). The low quality of the serving cell measurement (e.g., low measurement value of RSSI/RSRP/RSRQ/SINR) may be associated with a less relaxed measurement (e.g., less relaxed/short measurement cycle).

The WTRU 200 may determine a mode of measurement (e.g., whether to use MR or not) based on the band difference between the band of the MR 202 and the band of the LP-WUR 204 (e.g., NR frequency band), In one example, if the band difference/gap (e.g., between the MR and the LP-WUR 204) is smaller than the configured bandwidth threshold, the WTRU 200 may perform measurements only with LR for determination of measurement relaxation. For example, the WTRU 200 may determine to perform relaxed RRM measurement for intra frequency/inter-frequency if the serving cell measurements via LR is above the quality for relaxation threshold of the LP-WUR 204. If the band difference (e.g., between MR 202 and the LP-WUR 204) is larger than the configured bandwidth threshold, the WTRU may also perform measurements with the MR 202 during activation of the LP-WUR 204 or LP (e.g., measurement MR and LR).

The WTRU 200 may perform measurements for a serving cell and neighboring cells based on first sets of the reference signals (RSs) for the MR 202 and the second sets of RSs for the LP-WUR 204. For example, the WTRU 200 may determine a set of monitoring configurations based on the measured qualities. If the gap of measured quality in the LP-WUR 204 and the measured quality in the MR 202 is smaller than a first threshold (e.g., low difference), the WTRU 200 may determine a first set of monitoring configurations (e.g., longer periodicity) among the configured list of configurations. If the gap of measured quality in the LP-WUR 204 and the measured quality in MR 202 is smaller than a second threshold and larger than the first threshold (e.g., high difference), the WTRU 200 may determine a second set of monitoring configurations (e.g., shorter periodicity) among the configured list of configurations.

The WTRU may determine the sets of the RSs (e.g., first set or second set) for measurements based on the determined monitoring configurations. For example, if the measuring instance is one of a monitoring occasion according to the determined monitoring configuration, the WTRU 200 may measure the first sets of RSs. When a set of monitoring configurations is applied, the WTRU 200 may determine a combined quality of measurements based on the first sets of the RSs and the second sets of the RSs. If the measuring instance is not one of a monitoring occasion according to the determined monitoring configuration, the WTRU 200 may measure the second sets of the RSs.

The WTRU 200 may transmit or receive a physical channel or reference signal according to at least one spatial domain filter. The term “beam” may be used to refer to a spatial domain filter. The WTRU 200 may transmit a physical channel or signal using the same spatial domain filter as the spatial domain filter used for receiving an RS (such as CSI-RS) or a SS block. The transmission by the WTRU 200 may be referred to as “target”, and the received RS or SS block may be referred to as “reference” or “source”. In such case, the WTRU 200 may be said to transmit the target physical channel or signal according to a spatial relation with a reference to the second (reference) physical channel or signal, such RS or SS block.

A spatial relation may be implicit, configured by RRC or signaled by MAC CE or DCI. For example, the WTRU 200 may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU 200 may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU 200 is configured with a quasi-colocation (QCL) assumption type D between corresponding antenna ports. Such association may be configured as a TCI (transmission configuration indicator) state. The WTRU 200 may indicate an association between a CSI-RS or SS block and a DM-RS by an index to a set of TCI states configured by RRC and/or signaled by MAC CE. Such indication may also be referred to as a “beam indication”.

The WTRU 200 may use Discontinuous Reception (DRX) in RRC_IDLE and RRC_INACTIVE state in order to reduce power consumption. The WTRU 200 may monitor one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO.

In multi-beam operations, the WTRU 200 may assume that the same paging message and the same Short Message are repeated in all transmitted beams and thus the selection of the beam(s) for the reception of the paging message and Short Message is up to WTRU implementation. The paging message is same for both RAN initiated paging and CN initiated paging.

The WTRU 200 may initiate a RRC Connection Resume procedure upon receiving RAN initiated paging. If the WTRU 200 receives a CN initiated paging in RRC_INACTIVE state, the UE moves to RRC_IDLE and informs NAS.

When SearchSpaceId other than 0 is configured for pagingSearchSpace, the WTRU 200 may monitor the (is +1)th PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0, 1, . . . , X−1, K=1, 2, . . . , S. The PDCCH monitoring occasions for paging which do not overlap with WTRU symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. If X>1, when the WTRU 200 detects a PDCCH transmission addressed to P-RNTI within its PO, the WTRU 200 is not required to monitor the subsequent PDCCH monitoring occasions for this PO.

The following parameters may be used for the calculation of PF:
T: DRX cycle of the WTRU (T is determined by the shortest of the WTRU specific DRX value(s), if configured by RRC and/or upper layers, and a default DRX value broadcast in system information. In RRC_IDLE state, if WTRU specific DRX is not configured by upper layers, the default value is applied);
N: number of total paging frames in T;
Ns: number of paging occasions for a PF;
PF_offset: offset used for PF determination; and
UE_ID: 5G-S-TMSI mod 1024.
   where parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter first-PDCCH-MonitoringOccasionOfPO is signalled in SIB1 for paging in initial DL BWP. For paging in a DL BWP other than the initial DL BWP, the parameter first-PDCCH-MonitoringOccasionOfPO is signaled in the corresponding BWP configuration. If the WTRU 200 has no 5G-S-TMSI, for instance when the WTRU 200 has not yet registered onto the network, the WTRU 200 shall use as default identity UE_ID=0 in the PF and i_s formulas above.

The WTRU 200 may monitor for or listen to the paging message to know about one or more of incoming calls, system information change, ETWS (Earthquake and Tsunami Warning Service) notification for ETWS capable WTRUs, CMAS (Commercial Mobile Alert System) notification and Extended Access Barring parameters modification. In a RRC Idle state, the WTRU 200 may monitor Short Messages transmitted with paging RNTI (P-RNTI) over DCI and monitor a Paging channel for CN paging using 5G-S-TMSI. In a RRC Inactive state, the WTRU 200 monitors Short Messages transmitted with P-RNTI over DCI and monitors a Paging channel for CN paging using 5G-S-TMSI and RAN paging using full-RNTI. In a RRC Connected state, a WTRU may monitor Short Messages transmitted with P-RNTI over DCI.

In 3GPP Release 15, a WTRU wake-up signal for Idle mode paging was introduced for WTRUs supporting NB-IoT or eMTC. Similar to the concept described above for connected mode, a WTRU may monitor for a wake-up signal at a time specified by T_gap before the paging occasion as shown in FIG. 3. If the WTRU receives an indication that there may be paging addressed to that WTRU in the next paging time window then the WTRU may monitor PDCCH during each paging occasion of that paging time window. The paging time window may be defined such that WTRUs with a very long DRX in the order of minutes (eDRX) and which may suffer from clock drift compared to the network timing may reliably receive paging.

FIG. 4 illustrates a comparison of the power saving enhancements defined in 5G NR Release 17 to Release 16 in idle inactive modes. In 3GPP Release 17, a wake-up signal for Idle mode paging is discussed. A paging early indication (PEI) in DCI format 2-7 transmitted prior to the paging occasion will indicate whether the WTRU has to monitor PDCCH and potentially PDSCH to receive a paging message. PEI also includes paging indication which indicates WTRU subgroups in one or more paging occasions to be used for paging and TRS availability indication for acquiring time/frequency synchronization for paging.

In Release 16, the WTRU had to wake-up to measure SS burst for time/frequency synchronization and monitor paging occasions (POs); however, in Release 17, the WTRU may maintain deep sleep if the WTRU does not receive PEI. In addition, if the WTRU receives PEI, the WTRU can wake up, measure TRS burst and receive POs. Another benefit of PEI is that the WTRU does not need to periodically wake up to maintain time/frequency synchronization for PO reception as PEI is able to indicate TRS burst for acquiring time/frequency synchronization.

Referring again to FIG. 2, the WTRU 200 may receive one or more configuration information for monitoring LP-WUS, paging and PEI. The configuration information may be delivered via one or more of SIB (e.g., SIB1), RRC and MAC CE. The one or more of configuration information may be one or more of the following:
WTRU ID
   In an example, the WTRU may receive WTRU ID. For example, 5G-S-TMSI mod 1024 may be used as a WTRU ID.
Paging related configurations
   nAndPagingFrameOffset
      In an example, the WTRU may receive information nAndPagingFrameOffset. Based on the received information, the WTRU may determine one or more of the following information.
         Number of total paging frames (N)
         In an example, the WTRU may receive/determine the information on number of total paging frames (N) (e.g., via nAndPagingFrameOffset). Candidate values for the number of total paging frames may be different for different serving cell SSB periodicity.
         Paging frame offset (PF_offset)
         In an example, the WTRU may receive/determine the information on paging frame offset (e.g., via nAndPagingFrameOffset).
   DRX cycle (T)
      In an example, the WTRU may receive information of DRX cycle of the WTRU (T is determined by the shortest of the WTRU specific DRX value(s), if configured by RRC and/or upper layers, and a default DRX value broadcast in system information.
      In an example, the WTRU may use a default value (e.g., In RRC_IDLE state, if WTRU specific DRX is not configured by upper layers, the default value is applied).
   Number of paging occasions (e.g., for a PF) (Ns)
      In an example, the WTRU may receive information of number of paging occasions (e.g., per PF) for paging operation. For example, the WTRU may receive one of 1, 2 or 4 paging occasions for paging operation.
PEI related configurations
   Search space set (e.g., by pei-SearchSpace)
      In an example, the WTRU may receive information of one or more search space sets (e.g., to monitor PDCCH for detection of DCI format 2_7 according to a Type2A-PDCCH CSS set).
   Number of paging occasions in PEI (e.g., N_PO\hat{ }PEI)
      In an example, the WTRU may receive information of number of paging occasions supported by PEI. For example, one of 1, 2, 4 or 8 may be indicated.
   PEI payload size (e.g., by payloadSizeDCI-2-7)
      In an example, the WTRU may receive information of PEI payload size. For example, up to 41 bits and 43 bits for licensed and unlicensed spectrums, respectively, may be indicated.
   PEI frame offset (e.g., by pei-FrameOffset)
      In an example, the WTRU may receive frame offset for PEI. For example, the WTRU may receive offset from the start of a reference frame for PEI-O (e.g., the start of a frame) to the start of a first paging frame of the paging frames associated with a number of PDCCH monitoring occasions for DCI format 2_7.
   PEI symbol offset (e.g., for PEI by firstPDCCH-MonitoringOccasionOfPEI-O)
      In an example, the WTRU may receive symbol offset for PEI. For example, the WTRU may receive offset (e.g., in number of symbols) from the start of the frame to the start of the first PDCCH monitoring occasion for DCI format 2_7.
   Number of subgroups (e.g., N_SG\hat{ }PO for PEI)
      In an example, the WTRU may receive information of total number of subgroups (e.g., for PEI). For example, the WTRU may receive one or both of subgroupsNumPerPO and subgroupsNumForUEID. Based on the received information, the WTRU may determine whether to use WTRU ID based subgrouping or CN based subgrouping. For example, one or more of the following may be used:
         In an example, if subgroupsNumForUEID is absent in subgroupConfig, the subgroup ID based on CN assigned subgrouping, if available for the WTRU, may be used.
         In an example, if both subgroupsNumPerPO and subgroupsNumForUEID are configured, and subgroupsNumForUEID has the same value as subgroupsNumPerPO, the subgroup ID based on UE_ID based subgrouping may be used in the cell.
         In an example, if both subgroupsNumPerPO and subgroupsNumForUEID are configured, and subgroupsNumForUEID<subgroupsNumPerPO,
         The subgroup ID based on CN assigned subgrouping, if available for the WTRU, may be used in the cell.
         Otherwise, the subgroup ID based on UE_ID based subgrouping may be used in the cell.
         If the WTRU has no CN assigned subgroup ID or does not support CN assigned subgrouping, and there is no configuration for subgroupsNumForUEID, the WTRU may monitors the associated PO.
Configurations for LP-WUS
   LP-WUS occasions (LOs) and LP-WUS monitoring occasions (MOs). (Hereafter, LP-WUS occasion (LO) may be interchangeably used with LP-WUS monitoring occasion (MO)).
      In an example, the WTRU may receive configurations of LOs. For example, based on the configurations of LOs, the WTRU may receive configurations of N*K MOs (e.g., by receiving N*K sets of resources) for each LO where N may be a number of beams corresponding to LP-WUS and K may be a number of LP-WUS MOs for each beam. The configuration of LOs (e.g., each LO) and/or MOs (e.g., each MO) may be based on one or more of the following:
         One or more of a sequence ID, a scrambling ID and cell ID
         In an example, the WTRU may receive a configuration of one or more of sequence ID, a scrambling ID and cell ID. For example, the WTRU may receive a LP-WUS in the LP-WUS resource by using a sequence which is generated by using the ID and/or data which is scrambled by using the ID (e.g., in time and/or frequency domain).
         Signal structure
         In an example, the WTRU may receive a configuration of signal structure. For example, the WTRU may receive one of support of preamble, preamble length (if configured), message type (e.g., sequence and/or encoded data), number of repetition and etc.
         Waveform
         In an example, the WTRU may receive a configuration of waveform. For example, the WTRU may receive one of OOK-1, OOK-4, OFDMA or etc. as a waveform of LP-WUS. For OOK-4, M can be additionally configured.
         Monitoring type
         In an example, the WTRU may receive a configuration of monitoring type. For example, the WTRU may receive one of continuous monitoring and duty-cycled monitoring.
         Frequency resources
         In an example, the WTRU may receive a configuration of absolute frequency resources. For example, the WTRU may receive a configuration based on one or more of RBs, subbands, BWPs and etc. to indicate frequency resources for receiving LP-WUS.
         In an example, the WTRU may receive a configuration of relative time resources. For example, the WTRU may receive frequency offset (e.g., in RBs/subbands/RBGs) from one or more reference resources
         Time resources
         In an example, the WTRU may receive a configuration of absolute time resources. For example, the WTRU may receive a configuration based on one or more of periodicity, offsets and etc. The indication of configuration may be based on OFDM symbols, us, slots and etc.
         In an example, the WTRU may receive an implicit configuration of time resources. For example, the WTRU may receive time offset (e.g., in symbols/subframes/frames) from one or more reference resources.
         The one or more reference resources may be one or more of the start of the frame, an associated paging frame, an associated paging occasion, one or more associated LOs (e.g., for MOs), an associated PEI search space, SSB (PSS or SSS in NR-SS), LP-SS and etc.
   Number of subgroups (e.g., for LP-WUS operation or for each LP-WUS MO)
      In an example, the WTRU may receive information of number of subgroups for LP-WUS. In an example, the number of subgroups may be total number of subgroups for LP-WUS operation. In another example, the number of subgroups may be a number of subgroups supported by each LO or MO.
      In another solution, the WTRU may determine number of subgroups based on the received information. For example, the WTRU may use the number of subgroups for PEI as the number of subgroups for LP-WUS. In another example, the WTRU may determine the number of subgroups for LP-WUS as a scaling factor*the number of subgroups for PEI. The scaling factor may be indicated via one or more of SIB, RRC and MAC CE.
   Size of LP-WUS information
      In an example, the WTRU may receive information of LP-WUS payload size. For example, up to 8, 16 or 24 bits may be indicated.
      The WTRU may receive size of LP-WUS information for each information type. For example, the WTRU may receive a first size of LP-WUS information for a first information type (e.g., for one or more of TRS availability indication, SI change, ETWS/CMAS information and etc.). The WTRU may receive a second size of LP-WUS information for a second information type (e.g., subgroup indication).
   LP-WUS frame offset
      In an example, the WTRU may receive frame offset for LP-WUS. For example, the WTRU may receive offset from the start of a reference frame for LP-WUS (e.g., the start of a frame) to the start of a first paging frame of the paging frames associated with LP-WUS monitoring for the WTRU.
   LP-WUS symbol offset
      In an example, the WTRU may receive symbol offset for LP-WUS. For example, the WTRU may receive offset (e.g., in number of symbols) from the start of the frame to the start of the first LP-WUS monitoring occasion (e.g., for monitoring LP-WUS).
Subgroup ID
   In an example, the WTRU may receive subgroup ID (e.g., for PEI and/or LP-WUS).
      For example, the WTRU may receive subgroup ID(s) from AMF via NAS signaling (e.g., in CN based subgrouping). In another example, the WTRU may determine the subgroup ID based on the WTRU ID and the total number of subgroups for WTRU ID based subgrouping.
      In an example, the WTRU may receive a subgroup ID for both PEI and LP-WUS). In another example, the WTRU may receive a first subgroup ID for PEI and a second subgroup ID for LP-WUS. In another example, the WTRU may receive a subgroup ID for PEI and determine a subgroup ID for LP-WUS based on the received information. In another example, the WTRU may determine subgroup IDs for PEI and LP-WUS, respectively, based on the received information (e.g., WTRU ID).

Referring again to FIG. 2, the WTRU 200 may determine one or more associated POs with the WTRU 200. For example, the WTRU 200 may determine one or more associated POs based on the WTRU ID. In an example, the WTRU 200 may determine PO ID based on i_s:floor (UE_ID/N) mod Ns. In another example, i_PO=((UE_IDmodN)−N_S+i_s) mod N_PO\hat{ }PEI may be used.

The WTRU 200 may determine one or more LOs associated with the WTRU 200. The WTRU 200 may determine the one or more LOs based on one or more of the following:
WTRU ID
   For example, the WTRU may determine the one or more LOs based on the WTRU ID. For example, an associated LO ID may be floor (UE_ID/N) mod N_LO wherein N_LO may be total number of LOs (e.g., for a PF).
Associated PO
   Based on the determined POs, the WTRU may determine one or more LOs. For example, a LO may be associated with each PO (e.g., based on time and/or frequency offset). The WTRU may determine a LO which is associated with the determined PO (e.g., based on the WTRU ID).
Associated PF
   For example, the WTRU may determine one or more associated PFs based on the WTRU ID. Based on the determined PFs, the WTRU may determine one or more LOs. For example, a LO may be associated with each PF (e.g., based on time and/or frequency offset). The WTRU may determine a LO which is associated with the determined PF (e.g., based on the WTRU ID).

The WTRU 200 may determine one or more MOs associated the WTRU. The WTRU 200 may determine the one or more MOs based on one or more of the following:
WTRU ID
   For example, the WTRU may determine the one or more LOs based on the WTRU ID.
Associated PO
   Based on the determined PO, the WTRU may determine one or more MOs. For example, one or more MOs may be associated with each PO (e.g., based on time and/or frequency offset). The WTRU may determine one or more MOs which is associated with the determined PO (e.g., based on the WTRU ID).
Associated LO
   Based on the determined LO, the WTRU may determine one or more MOs. For example, a LO may be associated with each PO (e.g., based on time and/or frequency offset). The WTRU may determine one or more MOs which is associated with the determined PO (e.g., based on the WTRU ID).
Associated PF
   For example, the WTRU may determine one or more associated PFs based on the WTRU ID. Based on the determined PFs, the WTRU may determine one or more LOs. For example, a LO may be associated with each PF (e.g., based on time and/or frequency offset). The WTRU may determine a LO which is associated with the determined PF (e.g., based on the WTRU ID).

The WTRU 200 may determine LP-WUS information based on the received information. For example, the WTRU 200 may determine whether to split the subgroup information into two or more LOs and/or MOs. For example, the WTRU 200 may determine whether to split the subgroup information based on the size of LP-WUS information. For example, the WTRU 200 may determine the number of subgroups based on the size of LP-WUS information (e.g., for subgroups) and the number of subgroups for LP-WUS. For example, if the size of LP-WUS information (e.g., for all LP-WUS or all subgroup information)>=required size of information for all subgroups (e.g., the number of all subgroups (e.g., for LP-WUS) if bitmap is used), the WTRU 200 may receive information of all subgroups within one associated LO or MO of the LP-WUS with the WTRU 200. If the size of LP-WUS information (e.g., for all LP-WUS or all subgroup information)<required size of information for all subgroups (e.g., the number of subgroups (e.g., for LP-WUS) if bitmap is used), the WTRU 200 may receive information of all subgroups within two or more associated LOs or MOs.

Based on the determination, the WTRU 200 may split the subgroup information into two or more LOs and/or MOs. The split of the subgroup information may be based on one or more of the following:
Number of subgroups for each LO or MO
   For example, the WTRU may receive a number of subgroups for each LO or MO (e.g., via one or more of SIB, RRC and MAC CE). Based on the number of subgroups, the WTRU may determine LOs or MOs indicating a set of subgroups. For example, if 8 subgroup is supported and 4 subgroups for each MO is indicated, then first 4 subgroup information may be indicated in a first MO and second 4 subgroup information may be indicated in a second MO.
Number of associated LOs/MOs
   For example, the WTRU may determine a number of subgroups for each LO or MO based on the number of associated LOs (e.g., per PO or paging frame e.g., within a same beam) or POs (e.g., per LO, PO or paging frame e.g., within a same beam). The WTRU may receive S subgroups in each MO wherein S may be total number of subgroups/K (number of MOs within a LO with a same beam).
Based on a number of subgroups for PEI
   For example, the WTRU may receive a total number of subgroups for PEI (e.g., via one or more of SIB, RRC and MAC CE). For example, the WTRU may receive indication of the total number of subgroups for PEI in each LO or MO. For example, if 8 subgroups are configured for PEI and 16 subgroups are configured for LP-WUS, then a first MO may indicate a first 8 subgroup and a second MO may indicate a second 8 subgroup.

The WTRU 200 may determine a subgroup ID of the WTRU for LP-WUS. The determination may be based on one or more of the following:
Identical subgroup ID with PEI
   In an example, the WTRU may use a same subgroup ID used for PEI. The same subgroup ID may be used if number of subgroups for LP-WUS is same with number of subgroups for PEI (e.g., if number of subgroup in LP-WUS=number of subgroup in PEI).
Indicated subgroup ID for LP-WUS
   In an example, the WTRU may receive an indication of a subgroup ID for LP-WUS (e.g., via one or more of NAS signaling from AMF, SIB, RRC and MAC CE).
Determined subgroup ID for LP-WUS
   In an example, the WTRU may determine a subgroup ID for LP-WUS. For example, the WTRU may determine a WTRU subgroup ID for LP-WUS based on the WTRU subgroup ID for PEI. For example, e.g., if number of subgroup in LP-WUS>number of subgroup in PEI, WTRU subgroup ID in LP-WUS may be WTRU subgroup ID in PEI*Number of subgroup in LP-WUS/number of subgroup in PEI (or indicated scaling factor)+mod(UE_ID, Number of subgroup in LP-WUS/number of subgroup in PEI (or indicated scaling factor)). In another example, e.g., if number of subgroup in LP-WUS<number of subgroup in PEI, WTRU subgroup ID in LP-WUS may be floor (WTRU subgroup ID/Number of subgroup in LP-WUS*number of subgroup in PEI).

The WTRU 200 may determine LOs and MOs to monitor LP-WUS. The WTRU 200 may monitor all LOs/MOs associated with the WTRU 200 (e.g., based on WTRU ID and the associated PO). In some examples, the WTRU 200 may monitor LOs/MOs associated with the WTRU's subgroup ID (e.g., among the LOs/MOs associated with the WTRU ID and the associated PO). In other examples, the WTRU 200 may only monitor LOs/MOs which indicates the determined WTRU's subgroup ID. Further, the WTRU 200 may monitor LOs/MOs delivering common information. For example, the WTRU 200 may monitor LOs/MOs delivering TRS availability information, SI change, ETWS/CMAS information and etc.

The WTRU 200 may apply indicated information via LP-WUS if the WTRU detects LP-WUS in the determined LOs and MOs. For example, if the WTRU detects SI change, the WTRU 200 may apply the indicated set of system information. For example, if the WTRU 200 detects SI change, the WTRU 200 may activate MR 202 and/or receive updated system information. If the WTRU 200 receives ETWS/CMAS information, the WTRU 200 may apply the indicated information. If the WTRU 200 detects TRS availability indication, the WTRU 200 may use the indicated information to identify TRS location for time/frequency synchronization when the WTRU monitors PDCCH (e.g., after activation of MR). If the WTRU detects LP-WUS indicating the WTRU's subgroup ID (e.g., for LP-WUS) in a received LP-WUS, the WTRU 200 may monitor PEI and/or the associated PO with the WTRU 200. If the WTRU 200 receives a paging message, the WTRU may respond e.g., send a PRACH.

The WTRU 200 may be configured to determine whether or how to support LR measurements based on MR measurements for entry condition. The WTRU 200 may also be configured to determine whether or how to support MR measurements based on LR measurements for an exit condition.

The WTRU 200 may receive one or more the following information (e.g., via one or more of SIB, RRC and MAC CE).
Configurations related to LP-WUS monitoring and paging
WTRU ID
Number of total paging frames
Number of paging occasions
Number of subgroups for LP-WUS
One or more offsets (e.g., paging frame offset and/or OFDM symbol offset)
Configuration of LP-WUS occasion (LO) and LP-WUS monitoring occasion (MO) (e.g., based on offset between paging frame and LO/MO) (e.g., based on offset between paging frame and LO/MO)
   In an example, each set of MOs associated with a LO
One or more RSs for LR measurement (e.g., Low Power Synchronization Signal (LP-SS))
   For example, the WTRU 200 may be configured with one or more sets of LP-SS resources and/or LP-WUS preambles for measuring quality of LR channel.
One or more RSs for MR (e.g., SSBs)
   For example, the WTRU 200 may be configured with one or more sets of SSBs and/or RS resources for measuring quality of MR channel.
One or more thresholds
   For example, one or more thresholds for determining a mode of operation of the WTRU 200 may be configured (e.g., to determine whether to support hybrid measurement or not).
   For example, one or more thresholds for entry condition (and/or activation) for MR of LP-WUS monitoring may be configured (e.g., in one or more of RSRP, RSRQ, and RSSI).
   For example, one or more thresholds for entry condition (and/or activation) for LR of LP-WUS monitoring may be configured (e.g., in one or more of LP-RSRP, LP-RSRQ, LP-RSSI, RSRP, RSRQ, and RSSI).
   For example, one or more thresholds for exit condition (and/or deactivation) for LR of LP-WUS monitoring may be configured (e.g., in LP-RSRP, LP-RSRQ, LP-RSSI, RSRP, RSRQ, and RSSI).
   For example, one or more thresholds for exit condition (and/or deactivation) for MR of LP-WUS monitoring may be configured (e.g., in RSRP, RSRQ, and RSSI).
One or more measurement configurations for LR
   For example, one or more measurement configurations may be configured with the WTRU. Each measurement configuration may include one or more of measurement window, measurement timer and etc.
   Each measurement configuration for LR may be associated with each threshold for entry threshold of MR. For example, a first measurement configuration may be associated with a first MR entry threshold and a second measurement configuration may be associated with a second NR entry threshold.
One or more measurement configurations for MR
   For example, one or more measurement configurations may be configured with the WTRU. Each measurement configuration may include one or more of measurement window, measurement timer and etc.
   Each measurement configuration for MR may be associated with each threshold for exit threshold of LR. For example, a first measurement configuration may be associated with a first LR exit threshold and a second measurement configuration may be associated with a second exit threshold.

The WTRU 200 may be configured/indicated or identify a set of band parameters related to MR 202 and LP-WUR 204 (e.g., LR), respectively. For example, the parameter may include:
One or more cell IDs
One or more band related parameters
   For example, a list of carrier frequencies may be configured.
One or more bandwidths
   For example, bandwidth for each band/bandwidth part/carrier frequency may be configured.

The WTRU may indicate one or more of the following information (e.g., to a gNB)
One or more LP-WUS monitoring activation time wherein each LP-WUS monitoring activation time is associated with WTRU 200 status (e.g., whether LR is activated or not)
   For example, the WTRU may indicate a first LP-WUS monitoring activation time (e.g., from two or more candidate values) and a second LP-WUS monitoring activation time (e.g., from two or more candidate values). For example, the first LP-WUS monitoring activation time may be applied if one or more of the following conditions are satisfied:
      The WTRU activated MR
      The WTRU only measured the one or more RSs for MR
      The WTRU deactivated LR
   In another example, the second LP-WUS monitoring activation time may be applied if one or more of the following conditions are satisfied:
      The WTRU activated LR
      The WTRU measured the one or more RSs for LR
      The WTRU measured the one or more RSs for LR and the one or more RSs for MR
      The WTRU deactivated MR
One or more wake up time to monitor PDCCH for paging and/or paging occasion (PO) wherein each wake up time is associated with WTRU status (e.g., whether MR is activated or not)
   For example, the WTRU may indicate a first wake up time (e.g., from two or more candidate values) and a second wake up time (e.g., from two or more candidate values). For example, the first wake up time may be applied if one or more of the following conditions are satisfied:
      The WTRU activated LR
      The WTRU only measured the one or more RSs for LR
      The WTRU deactivated MR
   In another example, the second wake up time may be applied if one or more of the following conditions are satisfied:
      The WTRU activated MR
      The WTRU measured the one or more RSs for MR
      The WTRU measured the one or more RSs for LR and the one or more RSs for MR
      The WTRU deactivated LR

The one or more LP-WUS monitoring activation time and/or the one or more wake-up times to monitor PDCCH for paging may be configured per one or more of WTRU, band, bandwidth and band combination.

Referring again to FIG. 2, the WTRU 200 may also be configured to determine a mode of operation for determination of entry/exit conditions. The determination may be based on the set of band parameters. For example, if the set of band parameters satisfy a first set of conditions, the WTRU 200 may determine a first mode of operation (e.g., single measurement mode i.e., measuring only the one or more RSs received by the MR 202 for determination of entry conditions and/or measuring only the one or more RSs received by the LP-WUR 204 or LR for determination of exit conditions). If the set of band parameters satisfy a second set of conditions, the WTRU 200 may determine a second mode of operation (e.g., hybrid measurement mode i.e., determination of additionally measuring the one or more RSs for LR for determination of entry conditions and/or additionally measuring the one or more RSs for MR for determination of exit conditions). For the first set of conditions, one or more of the following may be used:
If distance/difference between carrier frequency/band for MR and LR<a band difference threshold.
If bandwidth difference/ratio between MR band and LR band (e.g., MR bandwidth/LR bandwidth)<a bandwidth threshold.

For the second set of conditions, one or more of the following may be used:
If distance/difference between carrier frequency/band for MR and LR>a band difference threshold.
If bandwidth difference/ratio between MR band and LR band (e.g., MR bandwidth/LR bandwidth)>a bandwidth threshold.

The WTRU 200 may measure the one or more RSs received by the MR 202 (e.g., a MR measurement). Based on the MR measurement, the WTRU 200 may determine whether/how to activate LP-WUS monitoring and stop monitoring POs. For example, the WTRU 200 may determine whether to additionally measure the one or more RSs received by the LP-WUR 204. For example, if the MR measurement is larger than a first MR entry threshold of the one or more entry thresholds for the MR, the WTRU 200 may start monitoring LP-WUS and/or stop or discontinue monitoring PO (e.g., without additional measurement of the one or more RSs for LR). If the MR measurement is larger than other MR entry thresholds (e.g., a second MR entry threshold (e.g., smaller than the first MR entry threshold) or a third MR entry threshold (e.g., smaller than the second MR entry threshold)), the WTRU 200 may perform additional measurements by measuring one or more of the RSs received by the LR or LP-WUR 204 (e.g., after activating LR while monitoring POs). If the additional measurement based on the one or more RSs for LR is larger than the LR entry threshold, the WTRU 200 may start monitoring LP-WUS and stop monitoring POs. If the MR measurement is smaller than all the MR entry thresholds, the WTRU 200 may keep monitoring PDCCHs for paging and/or POs.

The WTRU 200 may determine a measurement configuration for additional measurement by the LR or LP-WUR 204 based on the measurement of the one or more RSs received by the MR 202. For example, if the MR measurement is larger than the second MR entry threshold (e.g., smaller than the first MR entry threshold), the WTRU 200 may apply a first measurement configuration for the measurement of LR (e.g., measuring the one or more RSs for LR during a first LR measurement window/timer). For example, if the MR measurement is larger than the third MR entry threshold (e.g., smaller than the second MR entry threshold), the WTRU 200 may apply a second measurement configuration for the measurement of LR (e.g., measuring the one or more RSs for LR during a second LR measurement window/timer). Based on the additional measurement by LR, the WTRU 200 may determine whether to monitor LP-WUS and stop monitoring POs (e.g., if the additional measurement is larger than the LR entry threshold).

The WTRU 200 may determine LP-WUS monitoring activation time based on WTRU status and/or the MR measurement. For example, if the WTRU 200 deactivated the LR (e.g., LP-WUR 204) and/or the MR measurement is larger than the first MR entry threshold, the WTRU 200 may start monitoring LP-WUS and/or stop monitoring PO after a first activation time (e.g., from the measurement of the one or more RSs received by the MR 202 (e.g., last symbol of the one or more RSs for MR)). If the LP-WUR 204 and/or the MR 202 measurement is larger than the other thresholds (e.g., the second MR entry threshold and the third MR entry threshold), the WTRU 200 may start monitoring LP-WUS and/or stop monitoring PO after a second activation time (e.g., smaller than the first activation time) (e.g., from the measurement of the one or more RSs received by the LR or LP-WUR 204 (e.g., last symbol of the one or more RSs for LR).

The WTRU 200 may determine a LP-WUS configuration (e.g., one more LOs and/or associated sets of MOs) for LP-WUS monitoring based on a satisfied MR entry threshold. For example, if the MR measurement is larger than the first MR entry threshold, the WTRU 200 may monitor LP-WUS in a first LO and/or a first set of MOs (e.g., with lowest overhead/reliability configuration). If the MR measurement is larger than the second MR threshold, the WTRU 200 may monitor LP-WUS in a second LO and/or a second set of MOs (e.g., with medium overhead/reliability configuration). If the MR measurement is larger than the third MR threshold, the WTRU 200 may monitor LP-WUS in a third LO and/or a third set of MOs (e.g., with highest overhead/reliability configuration).

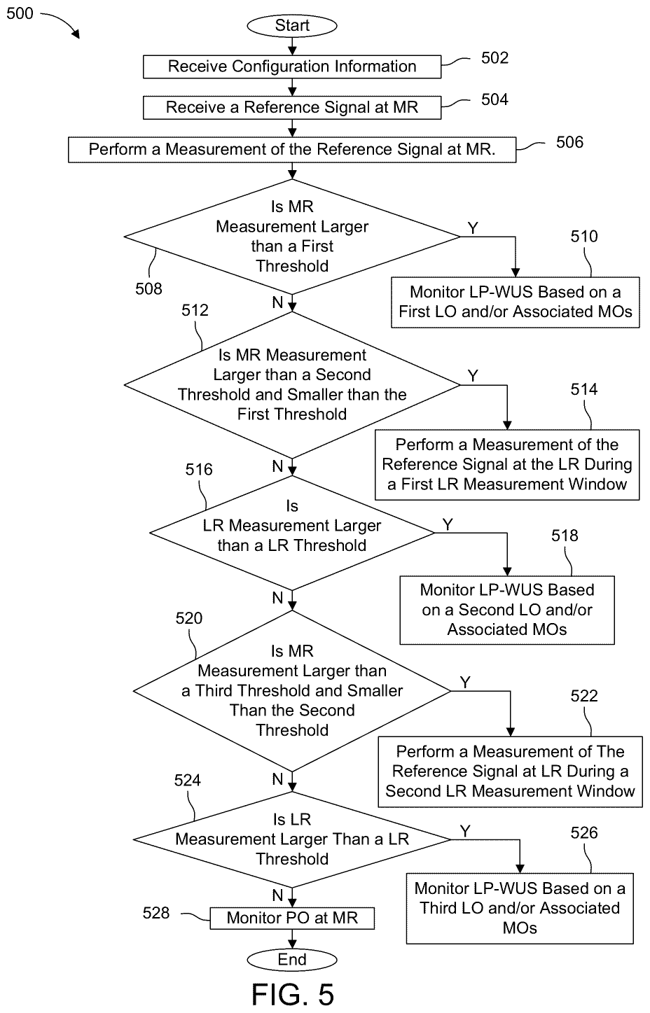

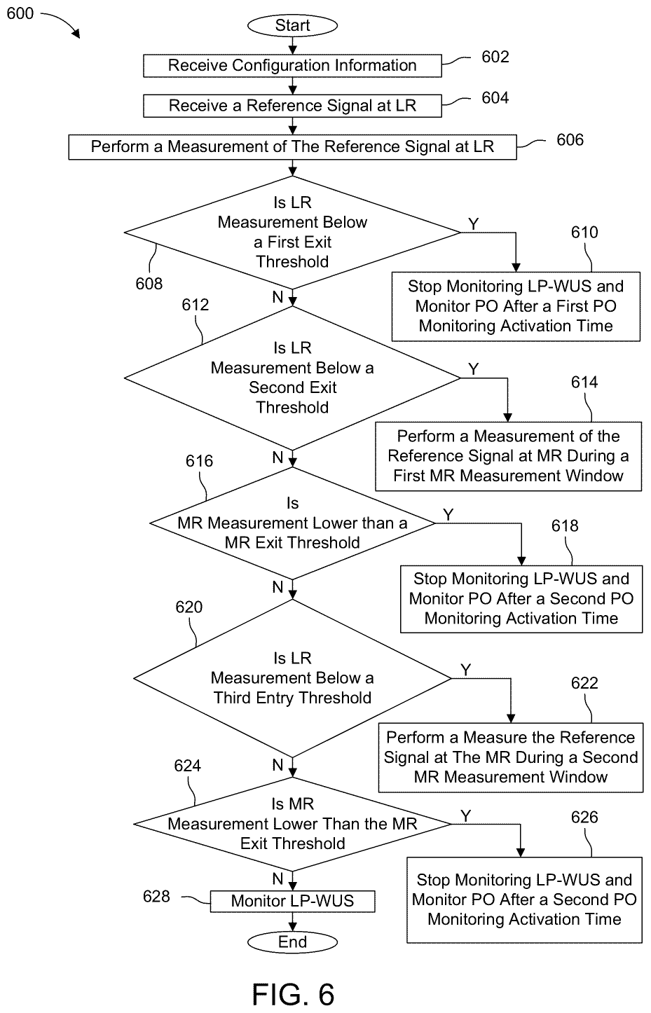

Referring now to FIG. 5, a flow diagram of a method 500 is illustrated for measurements for determining entry conditions. The method 500 may be implemented by a WTRU (e.g., WTRU 200). The method 500 enables efficient entry of LP-WUS monitoring by utilizing additional LR/MR measurements when a channel condition is relatively low and suspicious. The method 500 may enable a WTRU to determine whether and/or how to support LR measurements based on MR measurements for entry conditions. A method for enabling the WTRU to determine whether or how to support MR measurements based on LR measurements for exit conditions is described below in reference to FIG. 6.

At block 502, the method 500 involves receiving configuration information. For example, a WTRU may be configured with a first radio (e.g., main radio (MR 202)) and a second radio (e.g., a low power radio (LR or LP-WUR 204)). The WTRU may receive one or more of the following information (e.g., via one or more of SIB, RRC and MAC CE): one or more MR thresholds for entry condition of LP-WUS monitoring, one or more LR measurement windows wherein each LR measurement window is associated with each MR threshold for entry condition, a LR threshold for an entry condition of LP-WUS monitoring, one or more LR thresholds for exit conditions of LP-WUS monitoring, one or more MR measurement windows wherein each MR measurement window is associated with each LR threshold for exit condition, etc.

The WTRU may indicate one or more of the following information: one or more LP-WUS monitoring activation times wherein each LP-WUS monitoring activation time is associated with a status of the WTRU (e.g., whether LR is activated or not), one or more paging occasion (PO) monitoring activation time wherein each PO monitoring activation time is associated with WTRU status (e.g., whether MR is activated or not), etc.

At block 504, the method 500 involves receiving a reference signal. For example, the WTRU may receive one or more reference or a download (DL) signals. At block 506, method 500 involves performing a measurement of the reference signal. For example, the WTRU may measure one or more of the reference signal (RSs) received by the LP-WUR for LR measurement. In some examples, the WTRU 200 may be configured to measure the reference or downlink (DL) signal via the MR 202 (e.g., first radio) and/or the LP-WUR 204 (e.g., second radio). The reference signal may include at least one DL signal (e.g., SS/PBCH/SSB/SSS). For example, the WTRU 200 may receive a synchronization signal/physical broadcast channel (SS/PBCH) block. The measurement value of the DL signal received by the MR 202 (e.g., first radio) may include one or more measurement values (e.g., SS-RSRP and/or SS-RSRQ and/or SS-SINR). Based on the measurement, the WTRU may determine whether or how to measure the one or more reference signals (RFs) received by the second radio (e.g., LR measurement) based on the measurement of a signal via the MR (e.g., MR measurement). For example, the WTRU may determine whether to additionally measure the one or more RSs received by the second radio (LR).

At block 508, the method 500 involves determining whether the MR measurement is larger than a first entry threshold. If the MR measurement is larger than a first MR entry threshold of the one or more entry thresholds for MR, the method 500 involves monitoring LP-WUS based on a first LO and/or associated MOs (e.g., low overhead) at block 510. The method may also involve stopping or discontinuing PO monitoring after a first LP-WUS monitoring activation time (e.g., from the MR measurement)

At block 512, the method involves determining whether the MR measurement is larger than a second MR entry threshold and smaller than the first MR entry threshold. If the MR measurement is larger than a second entry threshold (e.g., smaller than the first threshold), the method 500 involves measuring one or more RSs for LR during a first LR measurement window at block 514

At block 516, the method 500 involves determining whether the LR measurement is larger than the entry threshold for LR. If the LR measurement is larger than the entry threshold for LR, the method 500 involves monitoring for a LP-WUS based on a second LO and/or associated MOs (e.g., medium overhead) at block 518. The method 500 may also involve stopping or discontinuing PO monitoring after a second LP-WUS monitoring activation time (e.g., from the LR RS measurement).

At block 520, the method 500 involves determining whether the MR measurement is larger than a third entry threshold (e.g., smaller than the second threshold). If the MR measurement is larger than a third entry threshold (e.g., smaller than the second threshold), the method 500 involves measuring the one or more RSs for LR during a second LR measurement window at block 522. For example, the WTRU may measure a reference signal received by the LR.

At block 524, the method involves determining whether the LR measurement is larger than the LR entry threshold. If the LR measurement is larger than the LR entry threshold, the method 500 involves monitoring for a LP-WUS based on a third LO and/or associated MOs (e.g., large overhead) at block 526. For example, the WTRU may be configured to monitor for a LP-WUS. The method 500 may also involve stopping or discontinuing PO monitoring after a second LP-WUS monitoring activation time (e.g., from the LR RS measurement). At block 528, the method involves monitoring a PO using the MR.

Referring again to FIG. 2, the WTRU 200 may also be configured to determine whether and/or how to support MR measurements based on LR measurements for an exit condition. The WTRU 200 may be configured with or may indicate determined LP-WUS related information (e.g., to a gNB). For example, the WTRU 200 may indicate the determined LP-WUS related information before starting to monitor for a LP-WUS. The WTRU 200 may be configured or indicated with the configuration information via one or more of PUCCH, PUSCH, MAC CE, RRC, PRACH, UL RS transmission (e.g., SRS, UL DMRS, UL PTRS and etc.). For example, the WTRU 200 may be configured or indicated with one or more of the following:
Satisfied MR entry threshold (e.g., one of the first MR entry threshold, the second MR entry threshold and the third MR entry threshold)
Determined LP-WUS monitoring configuration (e.g., one of the first LP-WUS monitoring configuration, the second LP-WUS monitoring configuration and the third LP-WUS monitoring configuration)
Used LR measurement configuration for additional measurement of the one or more RSs for LR
Required activation time for monitoring LP-WUS (e.g., one of the first activation time and the second activation time).

The WTRU 200 may measure one or more RSs by the LP-WUR 204 (e.g., LR) for a LR measurement. Based on the measurement, the WTRU 200 may determine whether and/or how to stop the LP-WUS monitoring and/or start monitoring POs. For example, the WTRU 200 may determine whether to additionally measure one or more RSs received by MR 202 for a MR measurement. For example, if the LR measurement is smaller than a first LR exit threshold of one or more exit thresholds for LR, the WTRU 200 may stop monitoring LP-WUS and/or start monitoring PO (e.g., without additional measurement of the one or more RSs for MR). If the LR measurement is smaller than other LR exit thresholds (e.g., a second LR exit threshold (e.g., larger than the first LR exit threshold) or a third LR exit threshold (e.g., larger than the second MR exit threshold)), the WTRU 200 may perform additional measurement by measuring one or more RSs for MR (e.g., after activating MR while monitoring LP-WUS). If the additional measurement based on the one or more RSs for MR is smaller than the MR exit threshold, the WTRU 200 may stop monitoring for a LP-WUS and start monitoring POs. If the LR measurement is larger than all the LR exit thresholds, the WTRU 200 may keep monitoring for a LP-WUS.

The WTRU 200 may determine a wake-up time (e.g., to start monitoring PDCCH for paging and/or POs from monitoring LP-WUS) based on the status of the WTRU 200 and/or the LR measurement. For example, if the WTRU 200 deactivated the MR and/or the LR measurement is smaller than the first LR exit threshold, the WTRU 200 may stop monitoring for a LP-WUS and/or start monitoring a PO after a first wake-up time (e.g., from the measurement of the one or more RSs for LR or the last symbol of the one or more RSs for LR)). If the WTRU 200 has activated the MR 202 and/or the LR measurement is smaller than the other thresholds (e.g., the second LR exit threshold and the third LR exit threshold), the WTRU 200 may stop monitoring LP-WUS and/or start monitoring a PO after a second wake up time (e.g., smaller than the first wake up time) (e.g., from the measurement of the one or more RSs for MR or the last symbol of the one or more RSs for MR).

The WTRU 200 may determine a PO configuration for monitoring PDCCH for paging and/or POs based on a satisfied LR exit threshold. For example, if the LR measurement is larger than the first LR exit threshold, the WTRU 200 may monitor PDCCH in a first set of POs (e.g., with highest overhead/reliability configuration). If the LR measurement is larger than the second LR exit threshold, the WTRU 200 may monitor PDCCH in a second set of POs (e.g., with medium overhead/reliability configuration). If the LR measurement is smaller than the third LR exit threshold, the WTRU 200 may monitor PDCCH in a third set of POs (e.g., with lowest overhead/reliability configuration).

The WTRU 200 may be configured or indicated with determined PO monitoring related information (e.g., to a gNB). The WTRU 200 may also be configured or indicated with the determined PO monitoring related information before starting to monitor PDCCH for paging and/or POs. The WTRU 200 may indicate the information via one or more of PUCCH, PUSCH, MAC CE, RRC, PRACH, UL RS transmission (e.g., SRS, UL DMRS, UL PTRS and etc.).

The WTRU 200 may be configured with or may indicate one or more of the following:
Satisfied LR exit threshold (e.g., one of the first LR exit threshold, the second LR exit threshold and the third LR exit threshold)
Determined PO monitoring configuration (e.g., one of the first PO monitoring configuration, the second PO monitoring configuration and the third PO monitoring configuration)
Used MR measurement configuration for additional measurement of the one or more RSs for LR
Required wake up time for monitoring POs (e.g., one of the first wake up time and the second wake up time).

Referring now to FIG. 6, a flow diagram of a method 600 is illustrated for MR and LR measurements for exit conditions. The method 600 may be implemented by a WTRU (e.g., WTRU 200) The method 600 enables efficient exit of LP-WUS monitoring by utilizing additional LR/MR measurements when channel condition is relatively low and suspicious. The method 600 may enable the WTRU 200 to determine whether or how to support MR measurements based on LR measurements for exit conditions.

At block 602, the method 600 involves receiving configuration information. For example, a WTRU may be configured with a first radio (e.g., main radio (MR)) and a second radio (e.g., a low power wake-up radio (LP-WUR)). The WTRU may receive one or more of the following information (e.g., via one or more of SIB, RRC and MAC CE). For example, the WTRU may receive one or more MR thresholds for entry condition of LP-WUS monitoring, one or more LR measurement windows wherein each LR measurement window is associated with each MR threshold for entry condition, a LR threshold for entry condition of LP-WUS monitoring, one or more LR thresholds for exit condition of LP-WUS monitoring, one or more MR measurement windows wherein each MR measurement window is associated with each LR threshold for exit condition, etc.

The WTRU 200 may be configured with or may indicate one or more of the following information: one or more LP-WUS monitoring activation times wherein each LP-WUS monitoring activation time is associated with a status of the WTRU (e.g., whether LR is activated or not), one or more paging occasion (PO) monitoring activation times wherein each PO monitoring activation time is associated a status of the WTRU (e.g., whether MR is activated or not).

At block 604, the method involves receiving a reference signal. For example, the WTRU may receive one or more reference signals (RSs) or download signals. The WTRU may measure the one or more RSs received by the second radio or LR or LP-WUR 204 (e.g., a MR measurement). At block 606, the method involves performing a measurement of a reference signal. For example, the WTRU may measure one or more of the RSs received by the LR (e.g., LR measurement). In some examples, the WTRU 200 may be configured to measure the reference or downlink (DL) signal via the MR 202 (e.g., first radio) and/or the LP-WUR 204 (e.g., second radio). The reference signal may include at least one DL signal (e.g., SS/PBCH/SSB/SSS). The measurement value of the DL signal received by the MR 202 (e.g., first radio) may include one or more measurement values (e.g., SS-RSRP and/or SS-RSRQ and/or SS-SINR). Based on the measurement, the WTRU may determine whether or how to measure the one or more RSs for a LR measurement based on the measurement. For example, the WTRU may determine whether to additionally measure the one or more RSs for LR.

At block 608, the method involves determining whether the LR measurement is below a first exit threshold (e.g., out of coverage). If the LR measurement is below a first exit threshold (e.g., out of coverage), the method 600 involves stopping or discontinuing the monitoring for a LP-WUS and monitoring a PO after a first PO monitoring activation time at block 610.

At block 612, the method 600 involves determining whether the LR measurement is below a second exit threshold (e.g., larger than the first exit threshold). If the LR measurement is below a second exit threshold (e.g., larger than the first exit threshold), the method 600 involves measuring one or more of the RSs received by the MR (i.e., MR measurement) during a first MR measurement window at block 614.

At block 616, the method 600 involves determining whether the MR measurement is lower than an exit threshold for MR. If the MR measurement is lower than the exit threshold for MR, the method 600 involves stopping or discontinuing the monitoring for a LP-WUS and monitoring a PO after a second PO monitoring activation time at block 618.

At block 620, the method 600 involves determining whether the LR measurement is below a third entry threshold. If the LR measurement is below a third entry threshold, the method 600 involves measuring one or more of the RSs for MR during a second MR measurement window at block 622.

At block 624, the method 600 involves determining whether the MR measurement is lower than the MR exit threshold. If the MR measurement is lower than the MR exit threshold, the method 600 involves stopping or discontinuing the monitoring for a LP-WUS and monitoring a PO after a second PO monitoring activation time at block 626. At block 628, the method 600 involves continuing monitoring for a LP-WUS.

Referring again to FIG. 2, the WTRU 200 may also be configured to measure signal received by the MR 202 and the LP-WUR 204 (e.g., LR) for determining a cell for camping. The WTRU 200 may perform cell selection with or without stored cell information. The cell information may include frequencies and/or cell parameters. The cell may be defined as a combination of one or more uplink component carriers (CC) and one or more downlink component carriers. The WTRU 200 may have (previously) stored information on one or more cells based on previously received measurement control information elements or from previously detected cells. If the WTRU 200 has stored cell information, the WTRU 200 may leverage it for cell selection.

When there is no stored information, or when a cell search based on the stored information has no results, the WTRU 200 may perform initial cell selection, where the WTRU 200 may have no prior knowledge of the cell parameters. For example, the WTRU 200 may not have knowledge of which RF channels are NR frequencies. As such, the WTRU 200 may scan and/or monitor one or more RF channels for example from a set of RF channels (e.g., based on the synchronization raster frequencies) in the NR bands to find a suitable cell. For example, a synchronization raster may indicate the frequency positions of the synchronization block (e.g., SS/PBCH block) that can be used by the WTRU 200 for system acquisition when explicit signaling of the synchronization block position is not present. As such, the WTRU 200 may search to find the SS/PBCH blocks (SSB) corresponding to one and more cells on each frequency channel and/or raster, where the WTRU 200 may select the strongest cell based on the measuring the RSSI, RSRP, RSRQ, SINR, and so forth for the detected SSB.

Upon finding a suitable cell, the WTRU 200 may select it as the serving cell. The WTRU 200 may use one or more criteria to select a candidate cell as a suitable cell. The WTRU 200 may determine the criteria based on one or more evaluated parameters. The WTRU 200 may determine the evaluated parameters based on one or more of measured parameters, compensation values, scaling rules, and so forth. As an example, the WTRU 200 may determine the compensation values and/or scaling rules based on one or more configured and/or indicated offsets, parameters, configured values. In an example, the WTRU 200 may be configured with, or determine one or more of the following parameters:
Measured cell received power value: For example, a WTRU may measure the reference signal received power (RSRP), signal-to-noise and interference ratio (SINR), received signal strength indicator (RSSI), and so forth for one or more SSBs, reference signals, and/or channels.
Measured cell quality value: For example, a WTRU may measure the reference signal received quality (RSRQ) for one or more SSBs, reference signals, and/or channels.
Minimum required measured RX power level and/or quality level in a cell. For example, a WTRU may receive, determine, or be configured with one or more parameters and/or offset values to determine the minimum required Rx level (e.g., in dBm) and/or minimum required quality level (e.g., dB) in the corresponding cell.
Compensation values: For example, a WTRU may receive, determine, or be configured with one or more parameters, offset, and/or scaling values that may be used upon receiving an indication, or based on WTRU determining based on one or more modes of operation, thresholds, and so forth.
Evaluated cell (re)selection Rx power level value: For example, a WTRU may compute, evaluate, and/or calculate the received power level value (e.g., in dB) based on one or more measured parameters and/or compensation and/or scaling values. In an example, the WTRU may calculate the evaluated cell (re)selection Rx power level value (e.g., Srxlev) based on the measured cell received power level value (e.g., Qᵣₓₗₑᵥₘₑₐₛ), the minimum required measured Rx power level (e.g., Qᵣₓₗₑᵥₘᵢₙ and/or Q_{rxlevminoffset}), the compensation parameters (e.g., P_{compensation}), one or more temporary offset values (e.g., Qoffsetₜₑₘₚ), and so forth (e.g., Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ). As such, the WTRU may select the corresponding cell as one of the candidate suitable cells if the evaluated cell (re)selection Rx power level value is higher than a (pre)configured threshold (e.g., Srxlev>0 for cell selection, or Srxlev>SintraSearchP or Srxlev>SnonIntraSearchP for intra-frequency and inter-frequency, respectively, cell reselection, and so forth).
Evaluated cell (re)selection quality value: For example, a WTRU may compute, evaluate, and/or calculate the received quality value (e.g., in dB) based on one or more measured parameters and/or compensation and/or scaling values. In an example, the WTRU may calculate the evaluated cell (re)selection quality value (e.g., Squal) based on the measured cell quality value (e.g., Q_{qualmeas}), the minimum required quality level (e.g., Q_{qualmin} and/or Q_{qualminoffset}), one or more temporary offset values (e.g., Qoffsetₜₑₘₚ), and so forth (e.g., Squal=Q_{qualmeas}−(Q_{qualmin}+Q_{qualminoffset})−Qoffsetₜₑₘₚ). As such, the WTRU may select the corresponding cell as one of the candidate suitable cells if the evaluated cell (re)selection quality value is higher than a (pre)configured threshold (e.g., Squal>0, or Squal>SintraSearchQ, or Squal>SnonIntraSearchQ for intra-frequency and inter-frequency, respectively, cell reselection, and so forth).

The WTRU 200 may receive or be configured with one or more of the compensation and/or scaling parameters, values, settings, and/or rules as the criteria for cell (re)selection via implicit and/or explicit indications. The explicit indications may be via master information block (MIB) in corresponding SSB, system information blocks (SIB), semi-static configuration (e.g., via RRC), dynamic indication (e.g., via MAC-CE and/or DCI), and so forth. The WTRU may determine to use one or more compensation and/or scaling rules based on implicit indication, that is based on comparing one or more parameters with corresponding thresholds for instance.

Upon measuring and calculating the evaluated received power and/or evaluated quality value, the WTRU 200 may perform cell ranking for all the cells (e.g., serving and neighbor cells) that the WTRU determined as the candidate suitable cells based on the cell selection criteria. For example, the WTRU 200 may determine the cell ranking based on the calculating the R values using average RSRP results. One or more of the following may apply. The following parameters are non-limiting examples of the parameters that may be included in cell ranking calculation and measurement. One or more of these parameters may be included. Other parameters may be included.

$$\begin{matrix}{R}_{s} = {Q}_{meas , s} + {Q}_{hyst} - {Qoffset}_{temp} \\ {R}_{n} = {Q}_{meas , n} - Qoffset - {Qoffset}_{temp}\end{matrix}$$

where, Rs and Rn correspond to the serving and neighbor cells, respectively. In an example, in the above equation, Qhyst may represent the mobility aspects of a WTRU. Qoffset may be configured with different values for intra-frequency and inter-frequency cell (re)selections, and Qmeas may be the measured RSRP quantity used in cell (re)selection.

The WTRU 200 may reselect a new candidate cell, if the new cell has higher R value than the serving cell during a (pre)configured time interval. The WTRU 200 may perform cell (re)selection based on a combination of measurements based on a first and a second radio. As shown in FIG. 2, the first radio may be a main radio (e.g., MR 202), and the second radio may be the low power wake-up radio 204 (LP-WUR). For example, the WTRU 200 may receive one or more configuration information and/or indications for performing cell (re)selection and/or selecting and/or determining a cell for camping on. In an example, the WTRU 200 may receive the configuration and/or indications, for example via RRC, MAC-CE, DCI, MIB, SIB, etc. The configuration information and/or indications may include but not limited to one or more of the following:
First sets of RSs. For example, a WTRU may receive, be configured, and/or indicated with a first set of RSs, where the WTRU may use the first set of RSs for measuring one or more quality parameters based on a first radio in two or more cells. For example, the first radio may be a main radio (MR). In an example, the first set of RSs may include SSBs, CSI-RSs, etc. For example, the quality parameters may include RSRP, RSRQ, etc. In an example, the WTRU may measure the quality parameters based on serving cell and one or more neighbor cells by using the configured first sets of RSs, where each set of first RSs may be associated with each cell.
Second sets of RSs. For example, a WTRU may receive, be configured, and/or indicated with a second set of RSs, where the WTRU may use the second set of RSs for measuring one or more quality parameters based on a second radio in two or more cells. For example, the second radio may be a low power radio (LR). In an example, the second set of RSs may include LP-SS, LP-WUS, etc. For example, the quality parameters may include LP-RSRP, LP-RSRQ, etc. In an example, the WTRU may measure the quality parameters based on serving cell and one or more neighbor cells by using the configured second sets of RSs, where each set of second RSs may be associated with each cell.
Threshold values. For example, a WTRU may be configured with a first threshold value for measuring one or more quality parameters in the first radio (e.g., a MR) for determining entry conditions, for example for LP-WUS monitoring. In another example, the WTRU may be configured with a second threshold value for measuring one or more quality parameters in the second radio (e.g., LR) for determining exit conditions, for example for LP-WUS monitoring. In another example, the WTRU may be configured with one or more bandwidth thresholds, based on which the WTRU may trigger measuring one or more quality parameters in the first radio (e.g., a MR). Moreover, in another example, the WTRU may be configured with one or more threshold values to be used along with one or more measured quality parameters.
Monitoring configurations. In an example, a WTRU may be configured and/or indicated with one or more sets of monitoring configurations (e.g., periodicity and/or offset) wherein each of the quality thresholds may be associated with each set of monitoring configurations.

The WTRU 200 may measure one or more quality parameters based on a first radio (e.g., a MR 202), for example in a serving cell and/or a cell the WTRU 200 has camped on. In case at least a measured quality parameter is higher than a configured first threshold, the WTRU 200 may determine that the LP-WUS entry condition is satisfied. In case the entry condition is satisfied, the WTRU 200 may activate LP-WUS monitoring.

When monitoring for LP-WUS, the WTRU 200 may determine the mode of measurement based on one or more conditions, threshold values, configurations, and/or indications. In an example, the WTRU 200 may determine the mode of measurement to be a first mode or a second mode, where the first mode may be measuring based on the first radio (e.g., MR 202) and the second mode may be measuring based on the second radio (e.g., LP-WUR 204). For example, in the first mode of measurement, the WTRU 200 may perform measurements based on the MR 202 during LR activation. In another example, in the second mode of measurement, the WTRU 200 may perform measurements only based on LR during LR activation.

The WTRU 200 may determine the mode of operation based on the difference between the first radio band (e.g., MR band) and the second radio band (e.g., LR band). In an example, the WTRU 200 may determine to use the second mode of measurement in case the band difference is lower than a corresponding determined, configured, and/or indicated bandwidth threshold. In another example, the WTRU 200 may determine to use the first mode of measurement in case the band difference is higher than the corresponding bandwidth threshold.

The WTRU 200 may measure one or more quality parameters for example in a serving cell and/or one or more neighboring cells. In an example, the WTRU 200 may perform the measurements based on the configured first set of RSs for the first radio (e.g., MR 202) and the WTRU 200 may perform the measurements based on the configured second set of RSs for the second radio (e.g., LP-WUR 204).

The WTRU 200 may determine a set of monitoring configurations for cell (re)selection based on one or more measured quality parameters in a first radio (e.g., MR 202) and a second radio (LP-WUR 204) based on one or more configuration information, indications, and/or threshold values. For example, the WTRU 200 may be configured with a first threshold and a second threshold on one or more quality parameters, where the first threshold may be lower than the second threshold. In another example, the WTRU 200 may determine, be configured, and/or indicated with a first set of monitoring configurations and a second set of monitoring configurations, where the first set of monitoring configurations may include longer periodicity, and the second set of monitoring configurations may include shorter periodicity.

The WTRU 200 may calculate and/or determine the difference between a measured quality parameter in a first radio (e.g., MR 202) with the measured quality parameter in a second radio (e.g., LP-WUR 204). In an example, in case the calculated difference is lower than the first configured threshold value (e.g., low difference), the WTRU 200 may determine to use the first set of monitoring configurations. In another example, in case the calculated difference is higher than the first configured threshold value (e.g., high difference), the WTRU 200 may determine to use the second set of monitoring configurations.

The WTRU 200 may determine the sets of RSs to be used for one or more measurements based on the determined monitoring configurations. In an example, if a measuring instance is configured based on the first monitoring configuration, the WTRU 200 may use the first set of RSs for performing one or more measurements. In another example, if a measuring instance is configured based on the second monitoring configuration, the WTRU may use the second set of RSs for performing one or more measurements. When the first set of RSs is used, the WTRU 200 may determine, estimate, and/or calculate one or more combined quality measurements based on the first and second sets of RSs. One or more of the following example combined quality measurements may be used:
Average. For example, a WTRU may use the measured quality parameters based on the first set of RSs and the measured quality parameters based on the second set of RSs and the WTRU may calculate the average value of the measured values.
Weighted average. For example, a WTRU may use the measured quality parameters based on the first set of RSs and the measured quality parameters based on the second set of RSs and the WTRU may calculate the weighted average value of the measured values. In an example, the WTRU may receive, be configured, and/or indicated with one or more weighted values for calculating the weighted average value. In another example, the WTRU may determine one or more weighted values for calculating the weighted average value based on the ratio of the first measurement window length used for measuring the first set of RSs to the second measurement window length used for measuring the second set of RSs. In another example, the WTRU may determine one or more weighted values for calculating the weighted average value based on the minimum and/or maximum value measured based on the first set of RSs and second set of RSs.
Prioritized. For example, a WTRU may determine, be configured, and/or indicated to prioritize the measurements based on the first or second set of RSs. For example, the WTRU may be configured to prioritize measurements based on first set of RSs in MR, for example within a time window from the MR measurement.

The WTRU may calculate one or more cell ranking parameters for a serving cell and one or more neighboring cells based on the determined radio, determined mode of measurement, determined measurement configurations, determined sets of RSs, and so forth. The WTRU may select the cell (e.g., best cell) based on the calculated cell ranking for camping on the cell.

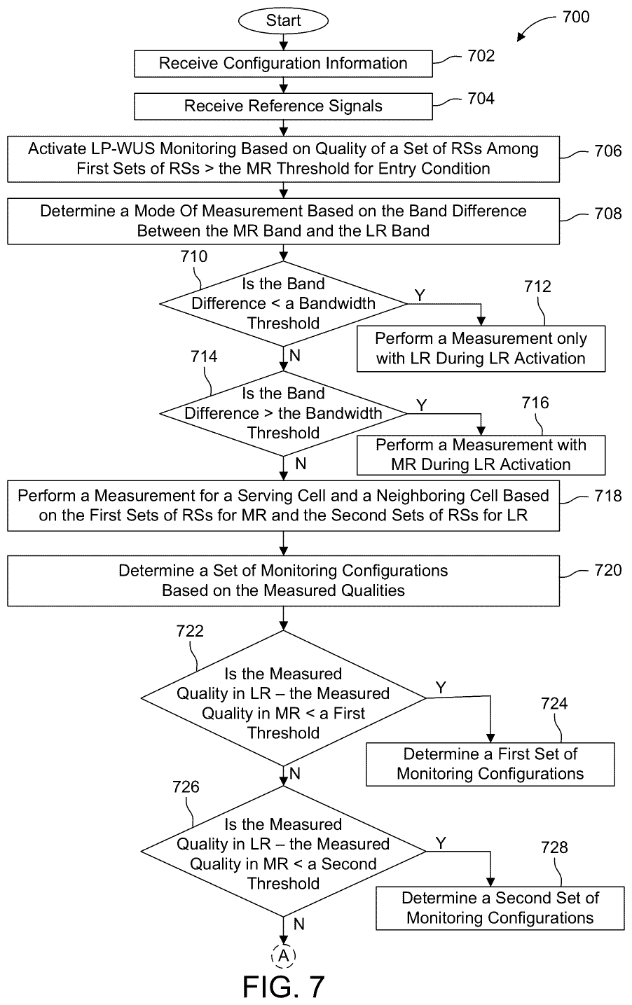

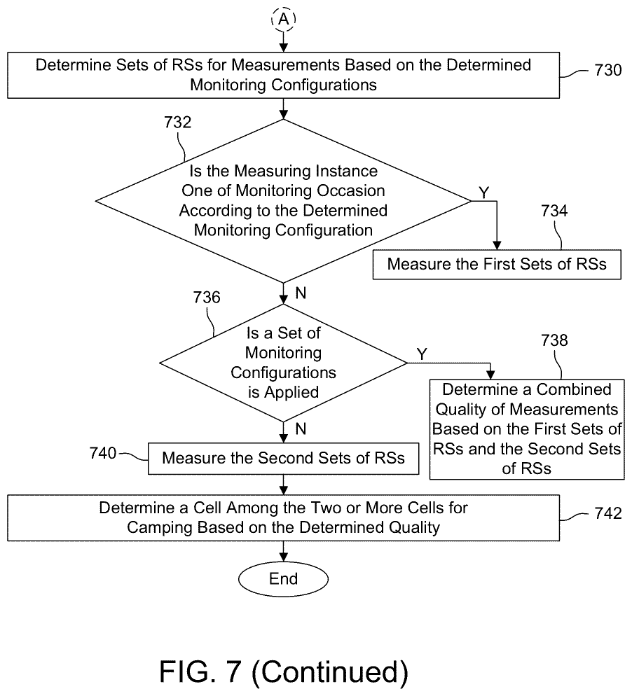

Referring now to FIG. 7, a flow diagram of a method 700, according to an exemplary embodiment, is illustrated for measurements of MR and LR for cell camping. The method 700 may be implemented by a WTRU (e.g., WTRU 200) to determine whether and/or how to support MR measurements during LP-WUS monitoring to determine a cell for camping.

At block 702, the method 700 involves receiving configuration information. For example, the WTRU may be configured with a first radio (e.g., main radio (MR)) and a second radio (e.g., a low power radio (LR)). The WTRU may receive one or more of the following configuration information (e.g., via one or more of SIB, RRC and MAC CE): a bandwidth threshold for triggering measurement by MR, one or more quality thresholds, one or more sets of monitoring configurations (e.g., periodicity and/or offset) wherein each quality threshold is associated with each set of monitoring configurations, etc.

At block 704, the method involves receiving reference signals. For example, the WTRU may receive one or more references or download signals. The WTRU may measure the one or more RSs received by the first radio (e.g., MR 202) for a MR measurement). At block 706, method 700 involves performing a measurement of a reference signal. The WTRU 200 may be configured to measure the reference or downlink (DL) signals via the MR 202 (e.g., first radio) and/or the LP-WUR 204 (e.g., LR or second radio). The reference signal may include at least one DL signal (e.g., SS/PBCH/SSB/SSS). The measurement value of the DL signal received by the MR 202 (e.g., first radio) may include one or more measurement values (e.g., SS-RSRP and/or SS-RSRQ and/or SS-SINR). Based on the measurement, the WTRU may determine whether or how to measure one or more of the RSs received by the LR (e.g., LP-WUR 204) for a LR measurement based on the MR measurement.

At block 706, the method 700 involves activating LP-WUS monitoring based on quality of a set of RSs (e.g., serving cell) among the first sets of RSs>a MR threshold for an entry condition. The method 700 may also involve determining whether to activate LP-WUS monitoring and/or to stop monitoring POs based on the measurement.

At block 708, the method 700 involves determining a mode of measurement (e.g., whether to use MR or not) based on the band difference between MR band and LR band. At block 710, the method involves determining whether the band difference<the bandwidth threshold. If the band difference<the bandwidth threshold, the method involves performing measurements only with LR during LR activation at block 712. At block 714, the method involves determines whether the band difference>the bandwidth threshold. If the band difference>the bandwidth threshold, the method 700 involves performing measurements with MR during LR activation at block 716.

At block 718, the method 700 involves performing measurements for a serving cell and neighboring cells based on the first sets of RSs for MR and the second sets of RSs for LR. At block 720, the method 700 involves determining a set of monitoring configurations based on the measured qualities. At block 722, the method involves determining whether the measured quality in LR—the measured quality in MR<a first threshold (e.g., low difference). If the measured quality in LR—the measured quality in MR<a first threshold, the method 700 involves determining a first set of monitoring configurations (e.g., longer periodicity) at block 724.

At block 726, the method 700 involves determining whether the measured quality in LR—the measured quality in MR<a second threshold (e.g., high difference). If the measured quality in LR—the measured quality in MR<a second threshold, the method 700 involves determining a second set of monitoring configurations (e.g., shorter periodicity) at block 728.

At block 730, the method 700 involves determining sets of RSs for measurements based on the determined monitoring configurations. At block 732, the method 700 involves determining whether the measuring instance is one of monitoring occasion according to the determined monitoring configuration. If the measuring instance is one of monitoring occasion according to the determined monitoring configuration, the method involves measuring the first sets of RSs at block 734.

At block 736, the method 700 involves determining whether a set of monitoring configurations is applied. If a set of monitoring configurations is applied, the method 700 determines a combined quality of measurements based on the first sets of RSs and the second sets of RSs at block 738. The combined quality of the measure may include an average of the measurements, a weighted average (e.g., by using coefficients configured by gNB or based on measurement window ratio, min/max value between two and etc.), prioritizing one value (e.g., prioritize MR measurement e.g., within a time window from the MR measurement), etc.

At block 740, the method involves measuring the second sets of RSs. At block 742, the method involves determining a cell (e.g., a best cell) among the two or more cells for camping based on the determined quality.

Referring again to FIG. 2, the WTRU 200 may be configured for measurement of the signals received by the MR 202 for a MR measurement and signals received by the LP or LP-WUR 204 for a LP measurement) for determining neighboring cell measurement relaxation. For example, The WTRU 200 may be configured for relaxed RRM measurement when a condition (e.g., cell re-selection procedure and relaxation threshold) is satisfied to the quality of the serving cell measurement with MR 202 or the LP-WUR 204 or LR. The WTRU 200 may determine whether to relax neighboring cell measurements based on the measurement relaxation thresholds with MR and LR. If the measured value of the MR measurement is above the first measurement relaxation threshold and the measured value of LR measurement is above the second measurement relaxation threshold, the WTRU 200 may be measuring only the serving cell. For example, if the MR measurement is not performed (e.g., within a time window), the WTRU 200 may assume that the MR measurement satisfies the first measurement relaxation threshold. If the measured value of the MR measurement is below the first measurement relaxation threshold and the measured value of LR measurement is below the second measurement relaxation threshold, the WTRU 200 may perform neighboring cell measurements (e.g., performing intra-frequency and inter-frequency measurement).

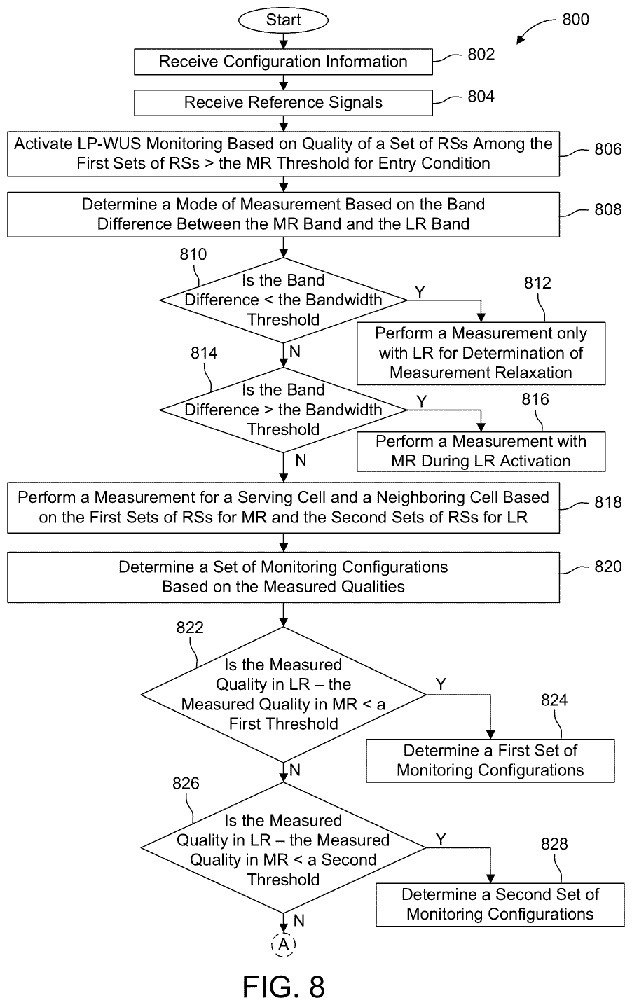

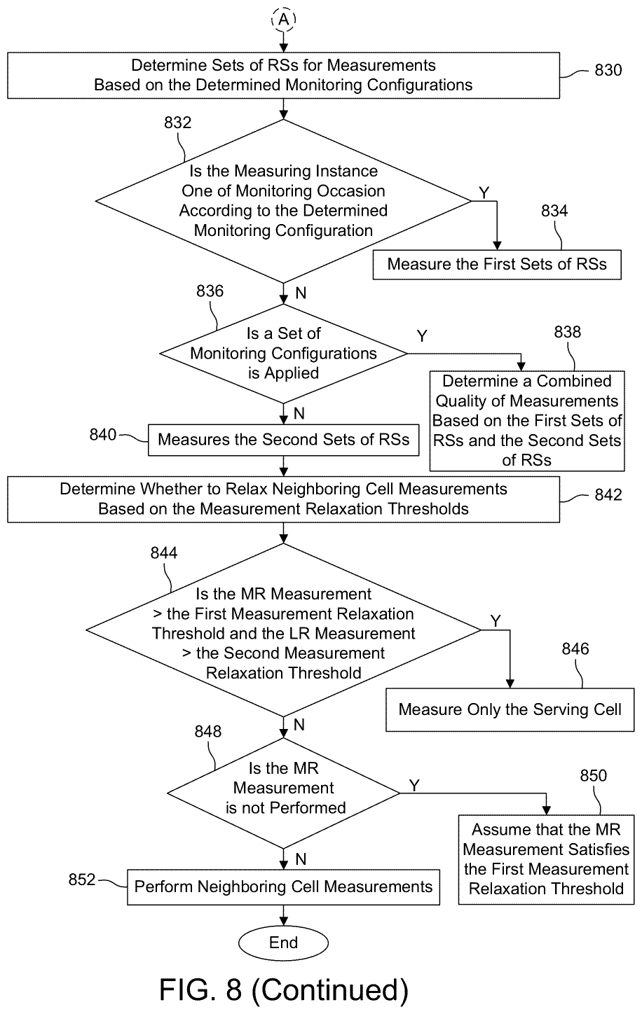

Referring now to FIG. 8, a flow diagram of a method 700, according to an exemplary embodiment, is illustrated for measurement of the MR and LR for neighboring cell measurement relaxation. The method 800 may be implemented by a WTRU (e.g. WTRU 200) to determine whether and/or how to support neighboring cell measurement relaxation.

At block 802, the method 800 involves receiving configuration information. For example, a WTRU may be configured with a first radio (e.g., main radio (MR)) and a second radio (e.g., a low power radio (LR)). The WTRU may receive one or more of the following configured information (e.g., via one or more of SIB, RRC and MAC CE): a bandwidth threshold for triggering measurement by MR, one or more quality thresholds and one or more sets of monitoring configurations (e.g., periodicity and/or offset) wherein each quality threshold is associated with each set of monitoring configurations, two measurement relaxation thresholds wherein a first measurement relaxation threshold is associated with MR measurements and a second measurement relaxation threshold is associated with LR measurements, etc.

At block 804, the method 800 involves receiving reference signals. For example, the WTRU may receive reference or download signals. The WTRU may measure one or more of the RSs received by the MR for a MR measurement and may measure the one or more RSs received by the LR for a LR measurement. Based on the measurement, the WTRU may determine whether or how to measure one or more of the RSs for LR measurement based on the MR measurement.

At block 806, the method 800 involves activating LP-WUS monitoring based on quality of a set of RSs (e.g., serving cell) among the first sets of RSs>the MR threshold for entry condition. At block 808, the method 800 involves determining a mode of measurements (e.g., whether to use MR or not) based on the band difference between MR band and LR band.

At block 810, the method 800 involves determining whether the band difference<the bandwidth threshold. If the band difference<the bandwidth threshold, the method 800 involves performing measurements only with LR for determination of measurement relaxation at block 812. At block 814, the method 800 involves determining whether the band difference>the bandwidth threshold. If the band difference>the bandwidth threshold, the method 800 involves performing measurements with MR during LR activation at block 818.

At block 818, the method 800 involves performing measurements for a serving cell and neighboring cell based on the first sets of RSs for MR and the second sets of RSs for LR. The WTRU may measure one or more of the RSs received by the LR (e.g., LR measurement). For example, the WTRU 200 may be configured to measure the reference or downlink (DL) signals via the MR 202 (e.g., first radio) and/or the LP-WUR 204 or LR (e.g., second radio). The reference signal may include at least one DL signal (e.g., SS/PBCH/SSB/SSS). For example, the WTRU 200 may receive a synchronization signal/physical broadcast channel (SS/PBCH) block. The measurement value of the DL signal received by the MR 202 (e.g., first radio) may include one or more measurement values (e.g., SS-RSRP and/or SS-RSRQ and/or SS-SINR).

At 820, the method involves determining a set of monitoring configurations based on the measured qualities. At block 822, the method 800 involves determining whether the measured quality in LR—the measured quality in MR<a first threshold (e.g., low difference). If the measured quality in LR—the measured quality in MR<a first threshold, the method 800 involves determining a first set of monitoring configurations (e.g., longer periodicity) at block 824. At block 826, the method involves determining whether the measured quality in LR—the measured quality in MR<a second threshold (e.g., high difference)). If the measured quality in LR—the measured quality in MR<a second threshold, the method 800 involves determining a second set of monitoring configurations (e.g., shorter periodicity) at block 828.

At block 830, the method 800 involves determining sets of RSs for measurements based on the determined monitoring configurations. At block 832, the method 800 involves determining whether the measuring instance is one of monitoring occasion according to the determined monitoring configuration. If the measuring instance is one of monitoring occasion according to the determined monitoring configuration, the method 800 involves performing measurements of the first sets of RSs at block 834. At block 836, the method 800 involves determining whether a set of monitoring configurations is applied. If a set of monitoring configurations is applied, the method 800 involves determining a combined quality of measurements based on the first sets of RSs and the second sets of RSs at block 838.

At block 840, the method 800 involves measuring the second sets of RSs. At block 842, the method 800 involves determining whether to relax neighboring cell measurements based on the measurement relaxation thresholds. At block 844, the method involves determining whether the MR measurement>the first measurement relaxation threshold and the LR measurement>the second measurement relaxation threshold. If the MR measurement>the first measurement relaxation threshold and the LR measurement>the second measurement relaxation threshold, the method 800 involves measuring only the serving cell at block 846.

At block 848, the method 800 involves determining whether the MR measurement is not performed (e.g., within a time window). If the MR measurement is not performed, the method 800 involves assuming that the MR measurement satisfies the first measurement relaxation threshold at block 850. At block 852, the method involves performing neighboring cell measurements.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a first radio;
a second radio; and
a processor configured to:
perform a first measurement of one or more reference signals received by the first radio;
cause the second radio to monitor for a low power wake-up signal based on a condition that the first measurement is larger than a first entry threshold;
perform a second measurement of one or more reference signals received, during a first measurement window, by the second radio based on a condition that the first measurement is larger than a second entry threshold; and
perform a third measurement of one or more reference signals received, during a second measurement window, by the second radio based on a condition that the first measurement is larger than a third entry threshold.

2. The WTRU of claim 1, wherein the processor is further configured to cause the first radio to monitor a paging occasion, and wherein the second radio is a low power wake-up radio.

3. The WTRU of claim 1, wherein the processor is further configured to cause the first radio to stop monitoring, after a first monitoring activation time, a paging occasion based on a condition that the first measurement is larger than a first entry threshold.

4. The WTRU of claim 1, wherein the processor is further configured to cause the second radio to monitor for a low power wake-up signal based on a condition that the second measurement is larger than a low-power entry threshold.

5. The WTRU of claim 4, wherein the processor is further configured to cause the first radio to stop monitoring, after a second monitoring activation time, a page occasion based on a condition that the second measurement is larger than a first entry threshold.

6. A wireless transmit/receive unit (WTRU) comprising:
a first radio;
a second radio; and
a processor configured to:
perform a first measurement of one or more reference signals received by the second radio;
cause the second radio to stop monitoring for a low-power wake up signal based on a condition that the first measurement is below a first exit threshold;
perform a second measurement of one or more reference signals received, during a first measurement window, by the first radio based on a condition that the first measurement is below a second exit threshold; and
perform a third measurement of one or more reference signals received, during a second measurement window, by the first radio based on a condition that the first measurement is larger than a third entry threshold.

7. The WTRU of claim 6, wherein the processor is further configured to cause the second radio to monitor for a low power wake-up signal, and wherein the second radio is a low power wake-up radio.

8. The WTRU of claim 6, wherein the processor is further configured to cause the first radio to monitor, after a first monitoring activation time, a paging occasion based on a condition that the first measurement is below a first exit threshold.

9. The WTRU of claim 8, wherein the processor is further configured to cause the second radio to stop monitoring for low power wake-up signals based on a condition that the second measurement is lower than a second exit threshold.

10. The WTRU of claim 9, wherein the processor is further configured to cause the first radio to monitor, after a second monitoring activation time, a paging occasion based on a condition that the second measurement is lower than a second exit threshold.

11. The WTRU of claim 6, wherein the processor is further configured to cause the second radio to stop monitoring for low power wake-up signals based on a condition that the third measurement is lower than a second exit threshold.

12. The WTRU of claim 9, wherein the processor is further configured to cause the first radio to monitor, after a second monitoring activation time, a paging occasion based on a condition that the third measurement is lower than a second exit threshold.

13. A method implemented by a wireless transmit/receive unit (WTRU), the method comprising:
performing a first measurement of one or more reference signals received by a first radio;
causing a second radio to monitor for a low power wake-up signal based on a condition that the first measurement is larger than a first entry threshold;
performing a second measurement of one or more reference signals received, during a first measurement window, by the second radio based on a condition that the first measurement is larger than a second entry threshold; and
performing a third measurement of one or more reference signals received, during a second measurement window, by the second radio based on a condition that the first measurement is larger than a third entry threshold.

14. The method of claim 13, further comprising causing the first radio to monitor a paging occasion, and wherein the second radio is a low power wake-up radio.

15. The method of claim 13, further comprising causing the first radio to stop monitoring, after a first monitoring activation time, a paging occasion based on a condition that the first measurement is larger than a first entry threshold.

16. The method of claim 13, further comprising causing the second radio to monitor for a low power wake-up signal based on a condition that the second measurement is larger than a low-power entry threshold.

17. The method of claim 16, further comprising causing the first radio to stop monitoring, after a second monitoring activation time, a page occasion based on a condition that the second measurement is larger than a first entry threshold.

18. The method of claim 13, further comprising:
performing a fourth measurement of one or more reference signals received by the second radio;
cause the second radio to stop monitoring for a low-power wake up signal based on a condition that the fourth measurement is below a first exit threshold;
performing a fifth measurement of one or more reference signals received, during a first measurement window, by the first radio based on a condition that the fourth measurement is below a second exit threshold; and
performing a sixth measurement of one or more reference signals received, during a second measurement window, by the first radio based on a condition that the fourth measurement is larger than a third entry threshold.

19. The method of claim 18, further comprising causing the second radio to monitor for a low power wake-up signal.

20. The method of claim 18, further comprising causing the first radio to monitor, after a first monitoring activation time, a paging occasion based on a condition that the first measurement is below a first exit threshold.
